(19) United States
(12) Patent Application Publication
(10) Pub. No.: US 2026/0270816 A1
(43) Pub. Date: Sep. 10, 2026

(54) TIMING AND AVAILABILITY SIGNALLING FOR FEEDER LINK SWITCH OVER IN NON-TERRESTRIAL NETWORKS

(71) Applicant: QUALCOMM Incorporated, San Diego, CA (US)

(72) Inventors: Geetha Priya RAJENDRAN, Bangalore, Karnataka (IN); Bharat SHRESTHA, San Diego, CA (US); Prasad Reddy KADIRI, San Diego, CA (US)

(21) Appl. No.: 18/873,700

(22) PCT Filed: Aug. 4, 2023
(86) PCT No.: PCT/US2023/071710

§ 371 Date: Dec. 10, 2024

(30) Foreign Application Priority Data
Aug. 5, 2022 (IN) 202241044925

(51) Int. Cl. H04W 36/00; H04W 76/30; H04W 84/06

(52) U.S. Cl. CPC H04W 36/0079; H04W 76/30; H04W 84/06

(57) ABSTRACT

In a non-terrestrial network (NTN), a source cell may be configured to determine a first time period associated with a switch over of a feeder link from the source cell to a target cell. The source cell may be further configured to transmit the message indicating the switch over of the feeder link based on the first time period. The message may further indicate a second time period associated with an availability of the target cell. A user equipment (UE) may be configured to receive the message indicating the feeder link switch over from the source cell to the target cell and the second time period associated with availability of the target cell. The UE may establish a connection associated with the target cell based on the message.

### CROSS REFERENCE TO RELATED APPLICATION(S)

This application claims the benefit of Indian Provisional Application Serial No. 202241044925, entitled “TIMING AND AVAILABILITY SIGNALLING FOR FEEDER LINK SWITCH OVER IN NON-TERRESTRIAL NETWORKS” and filed on Aug. 5, 2022, the disclosure of which is expressly incorporated by reference herein in its entirety.

### BACKGROUND

### Technical Field

The present disclosure generally relates to communication systems, and more particularly, to signaling between user equipment (UE) and network entities related to timing and location for feeder link switch over and UE handover.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In a first aspect of the disclosure, a first method, a first computer-readable medium, and a first apparatus are provided. The first apparatus may be a user equipment (UE) or a component thereof. The first apparatus may be configured to receive, in a non-terrestrial network (NTN), a message indicating a feeder link switch over from a source NTN entity to a target NTN entity and a time period associated with the switch over. The first apparatus may be further configured to establish a connection associated with the target NTN entity based on the time period.

In a second aspect of the disclosure, a second method, a second computer-readable medium, and a second apparatus are provided. The second apparatus may be a source NTN entity or a component thereof. The second apparatus may be configured to determine a first time period associated with a switch over of a feeder link from the source NTN entity to a target NTN entity. The second apparatus may be further configured to transmit a message indicating the switch over of the feeder link based on the first time period, the message further indicating a second time period associated with an availability of the target NTN entity.

In a third aspect of the disclosure, a third method, a third computer-readable medium, and a third apparatus are provided. The third apparatus may be a target NTN entity or a component thereof. The third apparatus may be configured to obtain a feeder link at a first time period based on a switch over of the feeder link from a source NTN entity. The third apparatus may be further configured to establish a respective connection with each of a set of UE connected with the source NTN entity at the first time period based on a second time period indicated to each of the set of UE in a message from the source NTN entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating an example of a switch over of a feeder link in a non-terrestrial network (NTN).

FIG. 5 is a diagram illustrating an example of a hard switch over of a feeder link in an NTN.

FIG. 6 is a diagram illustrating an example of a soft switch over of a feeder link in an NTN.

FIG. 7 is a call flow diagram illustrating an example of connection establishment by a UE after feeder link switch over in an NTN.

FIG. 8 is a call flow diagram illustrating an example of connection release with redirection for a UE for a feeder link switch over in an NTN.

FIG. 9 is a diagram illustrating an example of redirection information included in a radio resource control (RRC) Connection Release message.

FIG. 10 is a flowchart illustrating an example method at a UE for connection establishment after a feeder link switch over in an NTN.

FIG. 11 is a flowchart illustrating an example method at a source NTN entity for providing connection establishment information to a set of UEs before radio link failure caused by feeder link switch over in an NTN.

FIG. 12 is a flowchart illustrating an example method at a target NTN entity for establishing a respective connection with each of a set of UEs upon feeder link switch over in an NTN.

FIG. 13 is a diagram illustrating an example of a hardware implementation for an example apparatus.

FIG. 14 is a diagram illustrating another example of a hardware implementation for another example apparatus.

FIG. 15 is a diagram illustrating a further example of a hardware implementation for a further example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

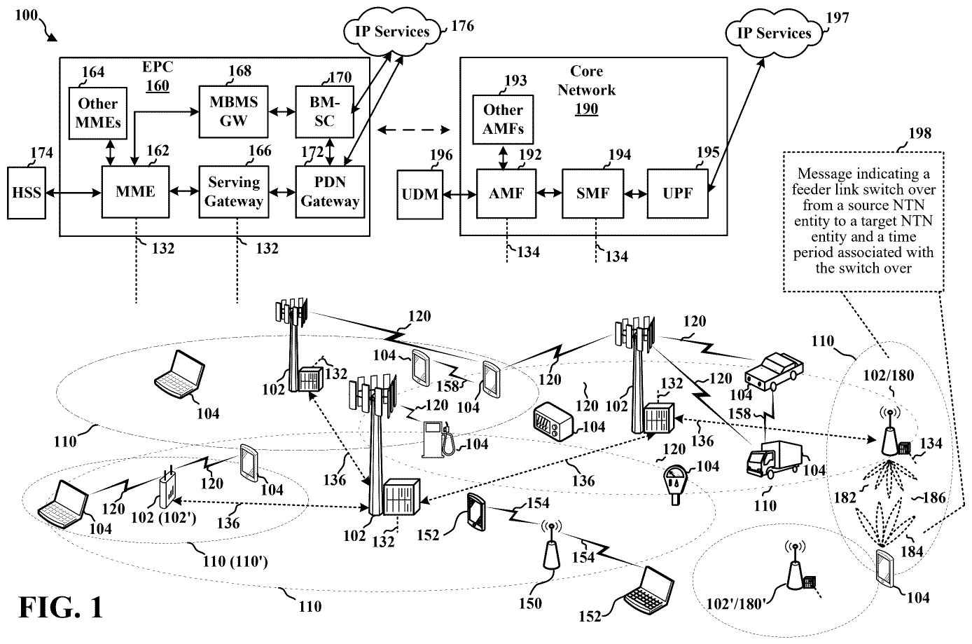

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation radio access network (RAN) (NG-RAN), may interface with core network 190 through second backhaul links 134.

In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for IAB.

At least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, a CU may implement some or all functionality of a radio resource control (RRC) layer, whereas a DU may implement some or all of the functionality of a radio link control (RLC) layer.

Illustratively, some of the base stations 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190.

With such a connection to the EPC 160 and/or core network 190, a base station 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mm Wave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102, whether a small cell 102′ or a large cell (e.g., macro base station), may include and/or be referred to as an eNB, gNodeB (gNB), or another type of base station. Some base stations 180, such as gNBs, may operate in a traditional sub 6 GHz spectrum, in mmW frequencies, and/or near-mmW frequencies in communication with the UE 104. When such a base station 180 (e.g., gNB) operates in mmW or near-mmW frequencies, the base station 180 may be referred to as a mmW base station. The (mmW) base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. Further, one or more of the base stations 102/180 may be encompassed by the terminology “network node” and/or “network entity.”

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects of the present disclosure, the wireless communications system and an access network 100 may include a non-terrestrial network (NTN). With an NTN, one or more of the base stations 102/180 may be connected with a gateway that may communicate with an NTN payload. For example, the NTN payload may be implemented through a satellite. The NTN payload may provide a feeder link to the gateway connected with a base station 102/180, and some or all connectivity and services available through the base station 102/180 may be provided through the feeder link to the NTN payload. An NTN entity may include any system or device configured to connect with or through an NTN, such as a base station and/or gateway and the like. For example, in one aspect, a base station 102/180 in communication with a UE 104 may be a source NTN entity when the UE 104 is handed over to a target NTN entity, such as the base station 102′/180′.

In certain aspects, the UE 104 may be configured to receive, in an NTN, a message indicating a feeder link switch over from a source base station 102/180 to a target base station 102′/180′ and a time period associated with the switch over (198). In some aspects, the message (198) may further indicate that the feeder link switch over is associated with a radio link failure or radio link interruption that may be experienced with the source base station 102/180, e.g., contemporaneously with the feeder link switch over. The UE 104 may establish a connection associated with the target base station 102′/180′ based on the message (198). For example, the UE 104 may establish the connection associated with the target base station 102′/180′ based on the time period associated with the switch over that is indicated by the message (198). In some aspects, the message (198) may further indicate information identifying the target base station 102′/180′ and/or a time period at which the target base station 102′/180′ is available for establishing the connection.

The source base station 102/180 may be configured to determine a first time period associated with a switch over of a feeder link from the source base station 102/180 to a target base station 102′/180′. The source base station 102/180 may be further configured to transmit (e.g., broadcast) the message (198) indicating the switch over of the feeder link based on the first time period. The message (198) may further indicate a second time period associated with an availability of the target base station 102′/180′. In some aspects, the message (198) may further indicate that the feeder link switch over is associated with a radio link failure or radio link interruption that may be experienced with the source base station 102/180, e.g., contemporaneously with the feeder link switch over. The UE 104 may establish a connection associated with the target base station 102′/180′ based on the message (198). For example, the UE 104 may establish the connection associated with the target base station 102′/180′ based on the time period associated with the switch over that is indicated by the message (198). In some aspects, the message (198) may further indicate information identifying the target base station 102′/180′ and/or a time period at which the target base station 102′/180′ is available for establishing the connection.

The target base station 102′/180′ may be configured to obtain a feeder link at a first time period based on a switch over of the feeder link from a source base station 102/180. The target base station 102′/180′ may be further configured to establish a respective connection with the UE 104 connected with the source base station 102/180 at the first time period based on a second time period indicated to each of the set of UE in the message (198) from the source base station 102/180.

In some aspects, the target base station 102′/180′ or an NTN Control function may notify the source base station 102/180 of the switch over of a feeder link from the source base station 102/180 to the target base station 102′/180′, the first time period at which the switch over is to occur, and/or whether the feeder link switch over is a hard switch over or a soft switch over. In some aspects, the target base station 102′/180′ or an NTN Control function may notify the source base station 102/180 of the second time period associated with the availability of the target base station 102′/180′. In some aspects, the target base station 102′/180′ or an NTN Control function may notify the source base station 102/180 of information identifying the target base station 102′/180′.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

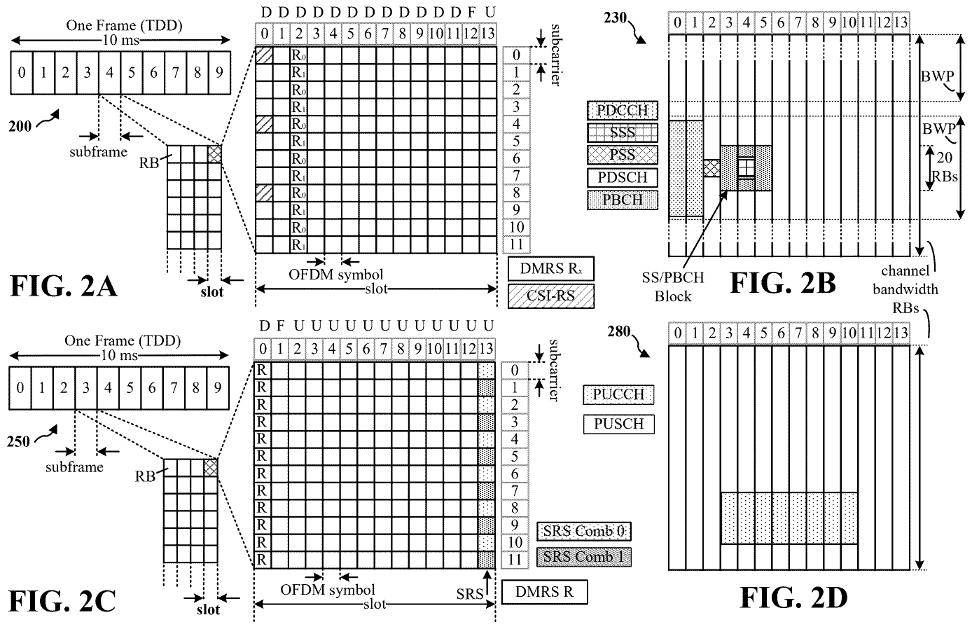

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2ⁿ slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

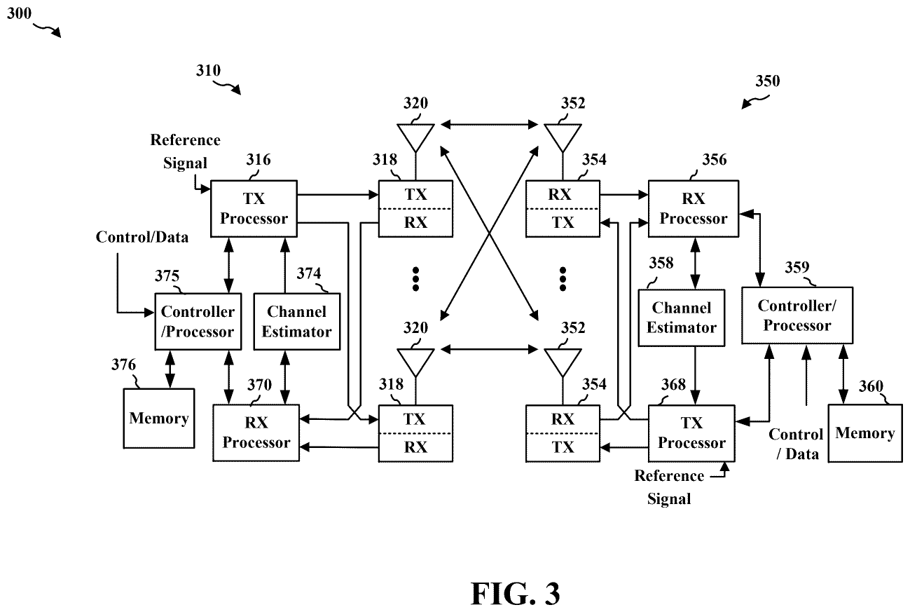

FIG. 3 is a block diagram of a base station 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with (198) of FIG. 1.

In some other aspects, at least one of the TX processor 316, the RX processor 370, and the controller/processor 375 may be configured to perform aspects in connection with (198) of FIG. 1.

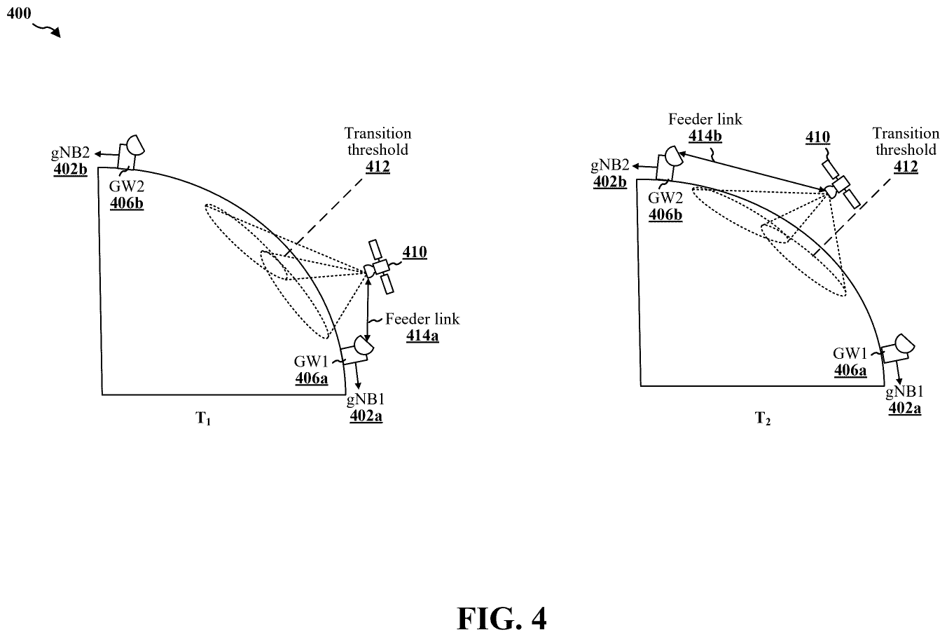

FIG. 4 is a diagram illustrating an example of a feeder link switch over in a NTN 400. A feeder link switch over is the procedure by which a feeder link is changed from a source NTN gateway (GW) 406a to a target NTN GW 406b for a specific NTN payload 410. The feeder link switch over is a Transport Network Layer procedure.

A feeder link switch over may result in transferring an established connection for a UE from a source gNB 402a to a target gNB 402b. Both hard and soft feeder link switch over are applicable to NTN. A hard switch over is a break-before-make switch over, whereas a soft switch over is a make-before-break switch over.

For a soft feeder link switch over, the NTN payload 410 is able to connect to two or more NTN GWs 406a, 406b during one time period, and therefore, a feeder link 414a through one NTN GW 406a may temporarily overlap with a feeder link 414b through another NTN GW 406b. Such a temporary overlap may reduce or eliminate the duration for which a UE lacks connectivity or a radio link.

For hard feeder link switch over, the NTN payload 410 is only able to connect to one NTN GW at a time. Consequently, the UE may experience a radio link failure or interruption during the transition between the feeder links 414a, 414b.

An NTN Control function may determine a point when a feeder link switch over between two gNBs 402a, 402b is performed. For example, a transition threshold 412 may be established, and once the NTN payload 410 reaches that transition threshold 412, feeder link switch over may be performed. The transfer of the context(s) of the affected UE(s) between the source gNB 402a and the target gNB 402b at a feeder link switch over is performed via one of various methods, such as an RRC Reestablishment procedure, UE handover, and/or an RRC Release procedure including an RRC Connection Release with Redirection. Different gNBs may be differently implemented and/or differently configured by the NTN Control function.

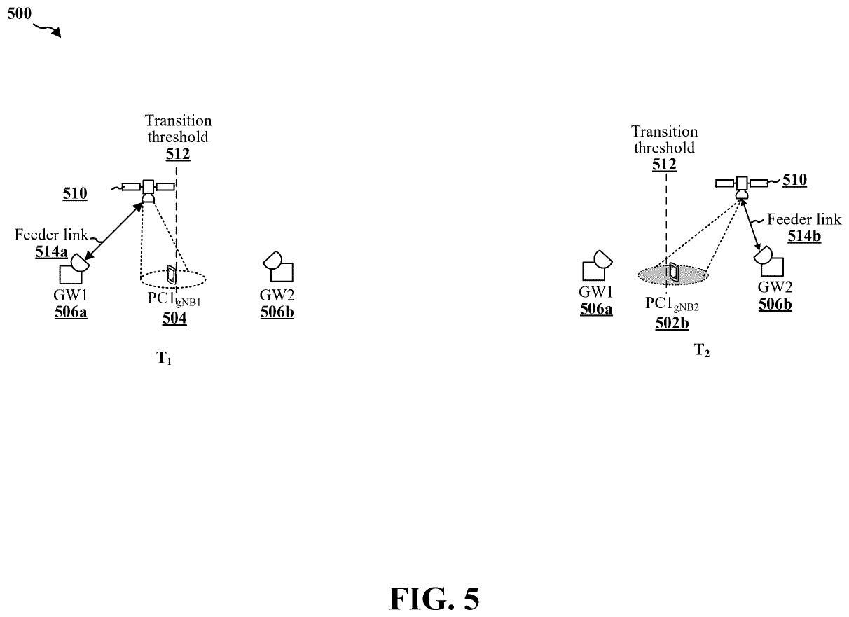

FIG. 5 is a diagram illustrating an example of a hard feeder link switch over in an NTN 500. A UE 504 may operate on a cell provided by a source gNB 502a because the source gNB 502a may be connected with the NTN through a first GW 506a, as the NTN payload is providing a feeder link 514a to the first GW 506a. However, the NTN payload 510 may cross the transition threshold 512, thereby triggering feeder link switch over. In the illustrated aspect, the NTN payload 510 is only able to maintain one feeder link at a time. Therefore, as the NTN payload 510 crosses the transition threshold 512 at time period T₁, the feeder link 514a provided to the first GW 506a may be terminated. The NTN payload 510 may switch over to providing a feeder link 514b to the second GW 506b. During this switch over, the UE 504 has not yet been handed over to or synchronized with the target gNB 502b. Therefore, the UE 504 experiences a radio link failure (RLF) or radio link interruption when the feeder link 514a to the first GW 506a is switched over to the feeder link 514b to the second GW 506b.

At time period T₂, the NTN payload 510 may have crossed the transition threshold 512 and the feeder link 514b to the second GW 506b may be established. Therefore, the target gNB 502b may be available to the UE 504. In some aspects, the UE 504 may be handed over from the source gNB 502a to the target gNB 502b via a conditional handover procedure, e.g., based on a conditional handover configuration provided to the UE 504 by the source gNB 502a. In some other aspects, the UE 504 may reestablish a connection, such as by performing an RRC Connection Reestablishment procedure with the target gNB 502b. For example, the UE 504 may transmit an RRC Connection Reestablishment Request to the target gNB 502b, and the target gNB 502b may respond with an RRC Connection Reestablishment message configuring RRC connection reestablishment with the UE 504. Based on the RRC connection reestablishment, the UE 504 may transmit an RRC Connection Reestablishment Complete message to the target gNB 502b.

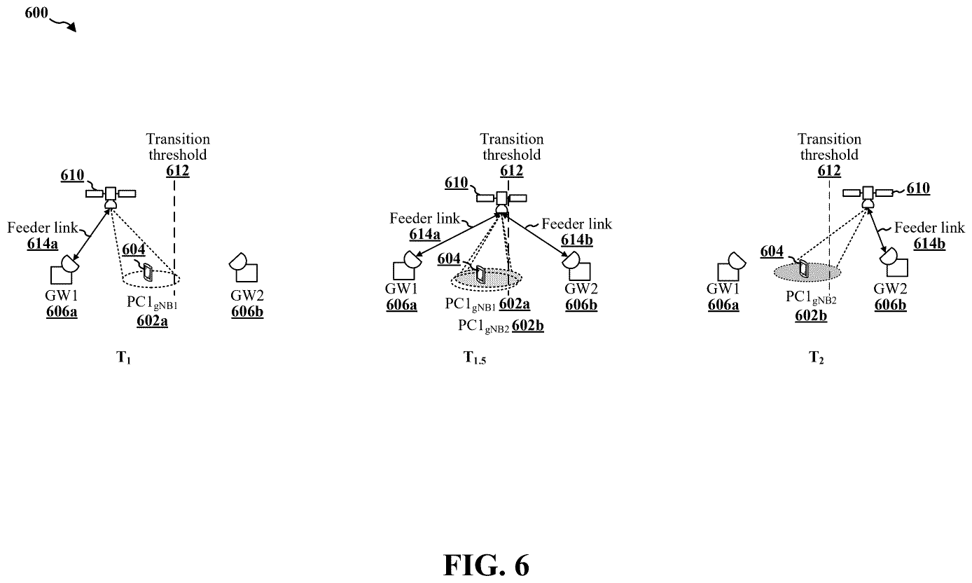

FIG. 6 is a diagram illustrating an example of a soft feeder link switch over in an NTN 600. A UE 604 may operate on a cell provided by a source gNB 602a because the source gNB 602a may be connected with the NTN through a first GW 606a, as the NTN payload is providing a feeder link 614a to the first GW 606a at time period T₁. At time period T_{1.5}, the NTN payload 610 may cross the transition threshold 612, thereby triggering feeder link switch over. In the illustrated aspect, the NTN payload 610 is able to contemporaneously maintain at least two feeder links. Therefore, as the NTN payload 610 crosses the transition threshold 612 at time period T_{1.5}, the feeder link 614a provided to the first GW 606a may remain active while a feeder link 614b is established with the target gNB 602b. During this switch over, the UE 604 may be handed over to the target gNB 602b, which may prevent the UE 604 from experiencing RLF or radio link interruption when the feeder link 614a to the first GW 606a is switched over to the feeder link 614b to the second GW 606b.

At time period T₂, the NTN payload 610 may have crossed the transition threshold 612 and the feeder link 614b to the second GW 606b may be established. As the UE 604 may have been handed over at time period T_{1.5}, the UE 604 may continue radio link communication at time period T₂, e.g., so that the feeder link switch over is largely transparent to the UE 604.

In some aspects, the UE 604 may be handed over from the source gNB 602a to the target gNB 602b via a conditional handover procedure, e.g., based on a conditional handover configuration provided to the UE 604 by the source gNB 602a. In some other aspects, the UE 604 may be handed over from the source gNB 602a to the target gNB 602b via a blind handover procedure, e.g., in which the UE 604 does not provide any measurements to the source gNB 602a for the handover procedure.

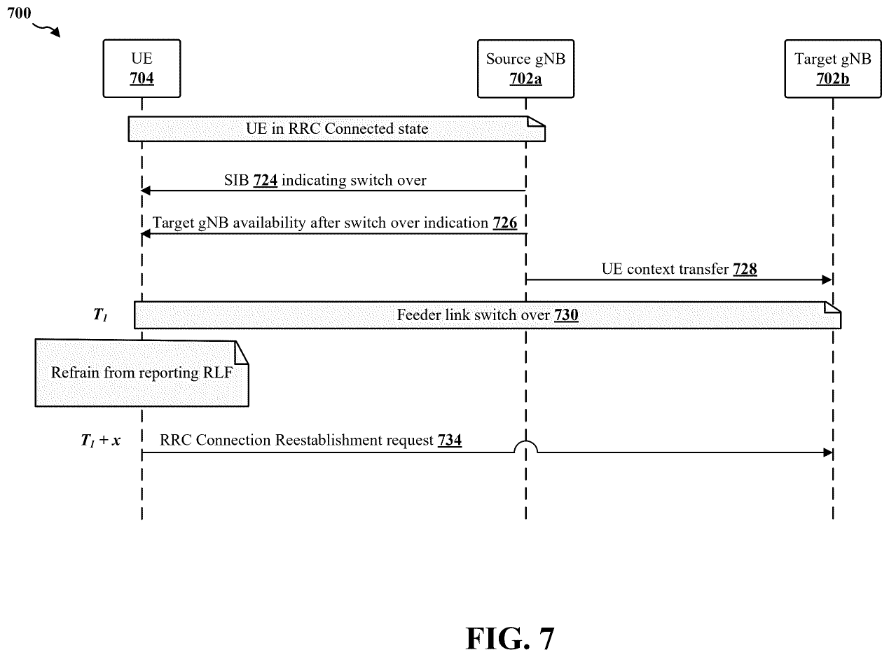

FIG. 7 is a call flow diagram illustrating an example flow of operations 700 for connection establishment by a UE 704 after feeder link switch over 730 in an NTN. In some aspects, the UE 704 may be an Internet-of-Things (IoT) UE or other IT device.

Prior to time period T₁, the UE 704 may be connected with the source gNB 702a, and therefore, may operate in an RRC Connected state with the source gNB 702a. However, the source gNB 702a may determine that a feeder link switch over is to occur. Therefore, the source gNB 702a may transmit (e.g., broadcast) a SIB 724 indicating that the feeder link switchover is to occur. The source gNB 702a may further indicate the type of feeder link switch over (e.g., hard switch over or soft switch over) and/or the time period T₁ at which the feeder link switch over will occur. The source gNB 702a may further transmit (e.g., broadcast) an indication 726 of the target gNB 702b that will be next available after the feeder link switch over, and/or the time period T₁+x at which the target gNB 702b will be available after the feeder link switch over. In some aspects, the indication 726 may be included in the SIB 724. In some aspects, the indication 726 may be transmitted on the Uu interface.

In some aspects, the SIB may be a SIB19. For example, the SIB19 may be used in 5G NR NTNs. In some other aspects, the SIB may be a SIB3. For example, the SIB3 may be used in LTE networks, such as for NTN IoT.

At time period T₁ of the feeder link switch over, the source gNB 702a may be configured to transmit, to the target gNB 702b, a respective context associated with the UE 704 (as well as other UEs having a connection with the source gNB 702a at that time period). In some aspects, the source gNB 702a may transmit the UE context(s) over an Xn interface. For example, the source gNB 702a may transmit the UE context(s) using an XnAP control protocol. In some other aspects, the source gNB 702a may transmit the UE context(x) over an X2 interface (e.g., for NTN IoT in LTE).

In some aspects, the feeder link switch over 730 is a hard switch over. In some such aspects, the NTN payload may terminate the feeder link to the source gNB 702 a at time period T₁. the feeder link switch over 730 may occur, and therefore, the feeder link with the source gNB 702a may broken and the feeder link with the target gNB 702b may be established. In some aspects, the UE 704 may be handed over from the source gNB 702a to the target gNB 702b. The handover may be a conditional handover, which may be initiated by measurements performed by the UE 704. The source gNB 702a may provide a conditional handover configuration to the UE 704 prior to the time period T₁. The conditional handover configuration may configure at least one of the type of measurement(s) and/or the threshold(s) at which the handover may be triggered. In another example, the RRC connection between the UE 704 and the source gNB 702a may be terminated.

In some other aspects, the feeder link switch over 730 is a soft switch over. In some such aspects, the NTN payload may contemporaneously maintain a feeder link toward the source gNB 702a and a feeder link toward the target gNB 702b. In some aspects, during this time, the UE 704 may be handed over from the source gNB 702a to the target gNB 702b. In one example, the handover may be a conditional handover, which may be initiated by measurements performed by the UE 704. The source gNB 702a may provide a conditional handover configuration to the UE 704, which may configure at least one of the type of measurement(s) and/or the threshold(s) at which the handover may be triggered. In another example, the handover may be a blind handover, which may not be triggered by UE measurements.

Due to the feeder link switch over 730, the UE 704 may experience RLF or radio link interruption with the source gNB 702a. In some instances, the UE 704 may be configured to report RLF to the network. However, with feeder link switch over 730, the RLF is expected, and a radio link with the target gNB 702 b may be established shortly thereafter. Therefore, in some aspects, the UE 704 may be configured to refrain from reporting an RLF associated with the source gNB 702a, e.g., based on the SIB 724 indicating the switch over 730 (the switch over 730 being the cause of the RLF). In some aspects, to refrain from reporting the RLF, the UE 704 may be configured to detect the RLF associated with the source gNB 702a, but may be configured (e.g., based on the received SIB 724 indicating the switch over 730) to refrain from reporting the RLF. In some other aspects, to refrain from reporting the RLF, the UE 704 may be configured (e.g., based on the received SIB 724 indicating the switch over 730) to refrain from detecting for RLF with the source gNB 702a during a time period that is contemporaneous with the time period T₁ of the feeder link switch over 730. In aspects in which the switch over 730 is a soft switch over 730, the UE 704 may move to the target gNB 702 b before RLF occurs.

In some aspects, at time period T₁+x, the UE 704 may be configured to trigger a handover procedure based on the feeder link switch over 730. The handover procedure may be a conditional handover procedure, which may be based on measurements performed by the UE 704 at a particular time T₁+x. For example, the source gNB 702a may transmit a configuration for conditional handover to the UE 704 that may indicate the measurement(s) that the UE 704 is to perform at a particular time T₁+x and/or the measurement threshold(s) at which the UE 704 is to report to trigger handover. In some other aspects, in which the switch over 730 is a soft switch over, the handover procedure may be a blind handover procedure that is not based on measurement(s) and reporting from the UE 704.

In some aspects, the UE 704 may be further configured to identify the target gNB 702b based on indication 726 associated with the availability of the target gNB 702b. For example, the UE 704 may decode the received SIB 724 to obtain the indication 726 of one or more of a cell identifier (ID) (e.g., PCI) of the target gNB 702b, a carrier frequency of the target gNB 702b, an ARFCN of the target gNB 702b, a subcarrier spacing of SSBs transmitted by the target gNB 702b, and/or an SSB measurement and timing configuration associated with the target gNB 702b.

At time period T₁+x at which the target gNB 702b becomes available, the UE 704 may be configured to establish a connection associated with the target gNB 702b. For example, the UE 704 may synchronize or attach to the target gNB 702b. The UE 704 may establish the connection with the target gNB 702b based on the time period T₁+x at which the target gNB 702b is available following the feeder link switch over 730, which may be indicated in the received indication 726 (e.g., included in the SIB 724).

In some aspects, the UE 704 may establish a connection associated with the target gNB 702b by reestablishing an RRC connection with the target gNB 702b. For example, the UE 704 may be configured to transmit an RRC Connection Reestablishment request 734 to the target gNB 702b based on the time period T₁+x, and the UE 704 may be configured to reestablish an RRC connection through the target gNB 702b based on the RRC Connection Reestablishment request. Based on receiving the RRC Connection Reestablishment request 734, the target gNB 702b may transmit an RRC Connection Reestablishment Complete message to the UE 704, e.g., so that radio resources can be allocated to the UE 704 through the target gNB 702b.

In some other aspects, the UE 704 may establish a connection associated with the target gNB 702b by attaching to the target gNB 702b. For example, the UE 704 may synchronize with the target gNB 702b, such as by acquiring the MIB and/or one or more SIBs transmitted by the target gNB 702b, by performing a random access channel (RACH) procedure with the target gNB 702b, etc.

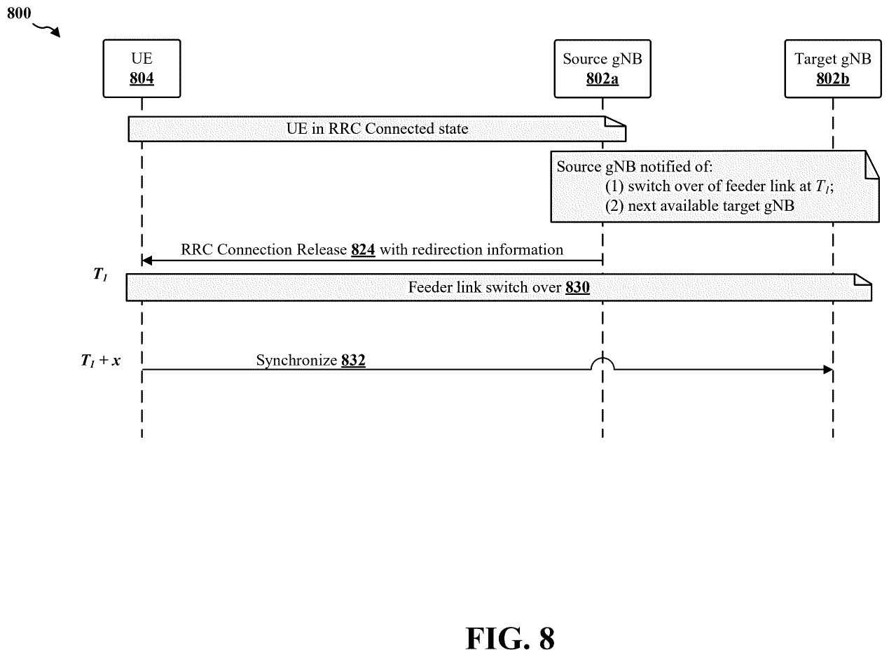

FIG. 8 is a call flow diagram illustrating an example flow of operations 800 for connection release with redirection for a UE 804 for a feeder link switch over 830 in an NTN. In some aspects, the UE 804 may be an Internet-of-Things (IoT) UE or other IoT device.

Prior to time period T₁, the UE 804 may be connected with the source gNB 802a, and therefore, may operate in an RRC Connected state with the source gNB 802a. The source gNB 802a may be notified (e.g., by an NTN Control function) of a feeder link switch over 730 at time period T₁. In some aspects, the source gNB 802a may be further notified of the type of switch over (e.g., hard or soft) and/or the next available target gNB 802b following the switch over 830 at the time period T₁.

Based on the notification (e.g., from the NTN Control Function), the source gNB 802a may transmit an RRC Connection Release message 824 to the UE 804 at the time period T₁. The RRC Connection Release message 824 may include redirection information. For example, the source gNB 802a may be notified of a (hard) switch over of a feeder link at a time period T₁, as well as the target gNB 802b that will be available after the feeder link switch over 830. The source gNB 802 a may include information indicating the target gNB 802b and the time period T₁+x at which the target gNB 802b will become available, which may be an offset x from the reference time period T₁ at which the feeder link switch over 830 occurs.

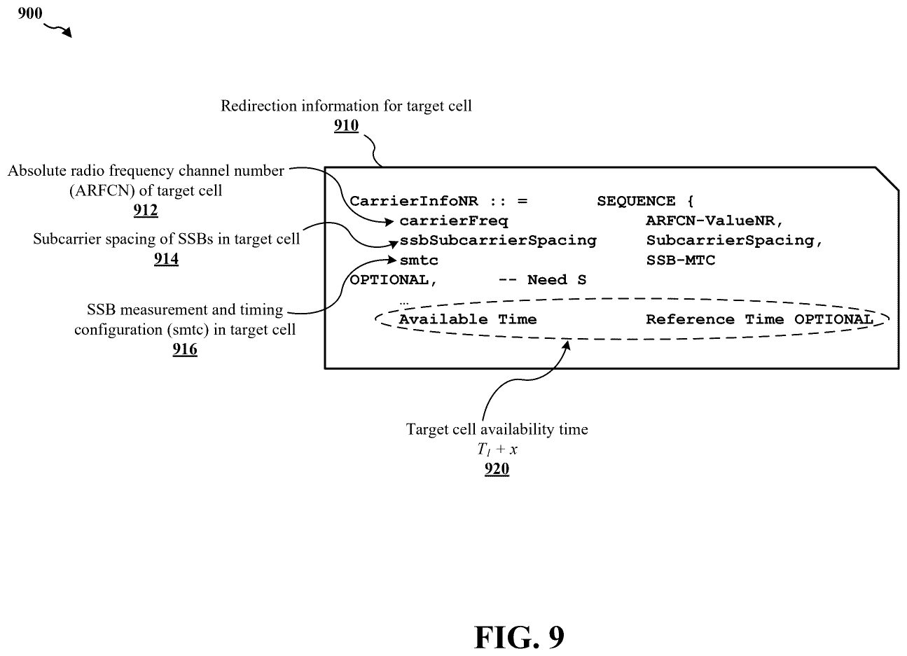

FIG. 9 is a diagram illustrating an example portion of an RRC Connection Release message 900 including redirection information 910. The redirection information 910 may indicate an ARFCN 912 of the target gNB 802b, a subcarrier spacing of SSBs 914 transmitted by the target gNB 802b, and/or an SSB measurement and timing (smtc) configuration 916 associated with the target gNB 802b, some or all of which may be used by the UE 804 to identify the target gNB 802b and/or operate on a cell provided by the target gNB 802b. The redirection information 910 may further indicate an availability time 920 at which the target gNB 802b is available after feeder link switch over 830. The availability time 920 may be indicated as a reference time (e.g., the feeder link switch over time period T₁) to which an offset x may be added or the availability time 920 may be indicated as an absolute or clock time period T₁+x at which the target gNB 802b will be available.

Again with reference to FIG. 8, at time T₁, the NTN payload may switch the feeder link over from the source gNB 802a to the target gNB 702b. In some aspects, the switch over 830 is a hard switch over. In some such aspects, the NTN payload may terminate the feeder link to the source gNB 802a and establish a feeder link with the target gNB 802b at the time period T₁.

The UE 804 may be configured to identify the target gNB 802b based on the redirection information 910 associated with the target gNB 802b included in the RRC Connection Release message 824. For example, the UE 804 may decode the received RRC Connection Release message 824 to obtain the information indicating one or more of a cell ID (e.g., PCI) of the target gNB 802b, a carrier frequency of the target gNB 802b, an ARFCN of the target gNB 802b, a subcarrier spacing of SSBs transmitted by the target gNB 802b, and/or an SSB measurement and timing configuration associated with the target gNB 802b. The UE 804 may tune receiver circuitry (e.g., circuitry of an RF front end and/or circuitry of a PHY layer) to the carrier frequency and/or ARFCN of the target gNB 802b.

At the availability time period T₁+x indicated in the redirection information 910, the UE 804 may be configured to establish a connection associated with the target gNB 802b. In some aspects, the UE 804 may establish a connection associated with the target gNB 802b by attaching or synchronizing 832 to the target gNB 802b. For example, the UE 804 may synchronize 832 with the target gNB 802b by acquiring the MIB and/or one or more SIBs transmitted by the target gNB 802b. In another example, the UE 804 may synchronize 832 with the target gNB 802b by performing a RACH procedure with the target gNB 802b.

In some aspects, the UE 804 may establish the connection with the target gNB 802b based on the redirection information 910 included in the RRC Connection Release message 824. For example, the UE 804 may decode and/or parse the redirection information 910 to obtain a carrier frequency, ARFCN, SSB subcarrier spacing, SSB measurement and timing configuration, and/or other information that may be used, alone or in the aggregate with other information, to identify the target gNB 802b and/or to operate on a cell provided by the target gNB 802b.

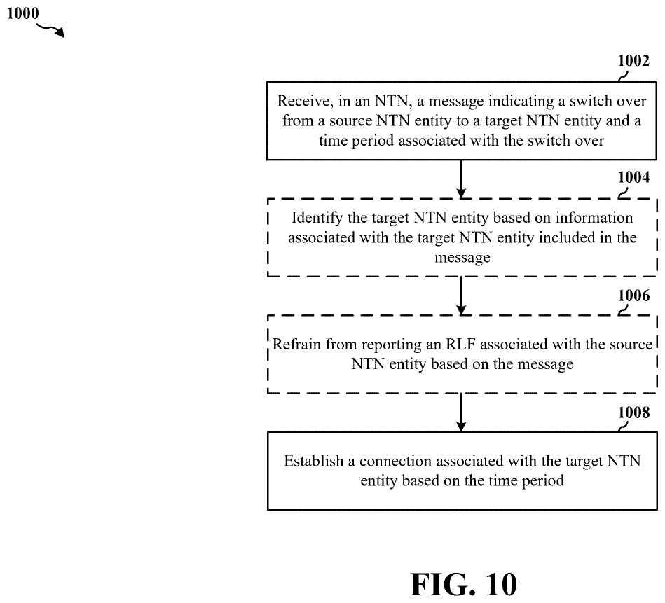

FIG. 10 is a flowchart of a method 1000 of wireless communication. The method 1000 may be performed by or at a UE (e.g., the UE 104, 350), another wireless communications apparatus, or one or more components thereof. According to various different aspects, one or more of the illustrated blocks of the method 1000 may be omitted, transposed, and/or contemporaneously performed.

At operation 1002, the UE may be configured to receive, in an NTN, a message indicating a feeder link switch over from a source NTN entity to a target NTN entity and a time period associated with the switch over. In some aspects, the message includes one of a SIB or a RRC Connection Release message. In some aspects, the SIB includes one of a SIB3 or a SIB19. In some aspects, the RRC Connection Release message includes redirection information, and the connection may be established further based on the redirection information.

In the context of FIG. 7, operation 1002 may be illustrated by the UE 704 receiving, in an NTN, the SIB 724 indicating a switch over 730. In some aspects, the SIB 724 may further indicate whether the feeder link switch over 730 at the time period T₁ is a hard switch over (e.g., as described with respect to FIG. 5, supra) or a soft switch over (e.g., as described with respect to FIG. 6, supra). Further, the UE 704 may receive the availability indication 726 for the target gNB 702b after the switch over 730. The UE 704 may receive the SIB 724 and/or the availability 726 of the target gNB 702 b prior to the time period T₁ at which the switch over 730 occurs. In some aspects, the availability 726 of the target gNB 702b may be indicated in the SIB 724. In some aspects, the availability 726 of the target gNB 702b may be indicated to the UE 704 as a time period T₁+x that is offset from the switch over time period T₁. In some further aspects, the availability 726 of the target gNB 702b may be indicated to the UE 704 as or with information identifying the target gNB 702b, such as a cell ID (e.g., a PCI), a carrier frequency, an ARFCN, and/or other information that may be used to locate and/or synchronize with the target gNB 702b.

In the context of FIG. 8, operation 1002 may be illustrated by the UE 804 receiving, in an NTN, the RRC Connection Release message 824. The UE 804 may receive the RRC Connection Release message 824 prior to a time period T₁ at which the switch over from the source gNB 802a to the target gNB 802b occurs. The RRC Connection Release message 824 may include redirection information that identifies the target gNB 802b. For example, in the context of FIG. 9, the RRC Connection Release message 824 may include the redirection information 910 for the target gNB 802b, and the redirection information 910 may indicate the ARFCN 912 of the target gNB 802b to which the UE 804 is to attach.

Further, the RRC Connection Release message 824 may indicate a time at which the target gNB 802b will be available for the UE 804 to be handed over from the source gNB 802a and/or available for the UE 804 to synchronize 830 with the target gNB 802b (such as by receiving the MIB and/or one or more SIBs, by performing a RACH procedure, etc.). For example, in the context of FIG. 9, the RRC Connection Release message 824 may include redirection information 910 that includes an Available Time field indicating the target gNB availability time 920, which may be indicated as a reference time (e.g., the feeder link switch over time period T₁) to which an offset x may be applied.

At operation 1004, in some optional aspects, the UE may be configured to identify the target NTN entity based on information associated with the target NTN entity included in the message. For example, the UE may decode the received message to obtain information indicating one or more of a carrier frequency of the target NTN entity, an ARFCN of the target NTN entity, a subcarrier spacing of SSBs transmitted by the target NTN entity, and/or an SSB measurement and timing configuration associated with the target NTN entity. The UE may tune receiver circuitry (e.g., circuitry of an RF front end and/or circuitry of a PHY layer) to the carrier frequency and/or ARFCN of the target NTN entity.

In the context of FIG. 7, operation 1002 may be illustrated by the UE 704 identifying the target gNB 702b based on information included in the SIB 724. In the context of FIG. 8, operation 1002 may be illustrated by the UE 804 identifying the target gNB 802b based on the redirection information included in the RRC Connection Release message 824. Referring to FIG. 9, for example, the RRC Connection Release message 824 may include the redirection information 910 indicating the ARFCN 912 that the UE 804 may use to tune receiver circuitry to the carrier frequency of the target gNB 802b.

At operation 1006, in some other optional aspects, the UE may be configured to refrain from reporting an RLF associated with the source NTN entity based on the message. The message may indicate, to the UE, that a feeder link switch over is to occur. If the feeder link switch over is a hard switch over at time period T₁, then the UE may (temporarily) lose connectivity to the NTN at time period T₁. In one example, the UE may refrain from reporting the RLF based on the indication that the switch over is associated with the RLF. In some aspects, to refrain from reporting the RLF, the UE may be configured to detect the RLF associated with the source NTN entity, but may be configured (e.g., based on the received message) to refrain from reporting the RLF. In some other aspects, to refrain from reporting the RLF, the UE may be configured (e.g., based on the received message) to refrain from detecting for RLFs during a time period that is contemporaneous with the time period Ty of the feeder link switch over.

In the context of FIG. 7, operation 1006 may be illustrated by the UE 704 refraining from reporting RLF contemporaneous with the feeder link switch over 730. Where a radio link to the NTN is unavailable to the UE 704 at the time period T₁ due to the (hard) feeder link switch over 730, the UE 704 may be configured to refrain from reporting an RLF that is associated with (e.g., caused by) the feeder link switch over 730. For example, the UE may be configured to detect the RLF associated with the source gNB 702a, which may result from the feeder link switch over 730. However, the UE 704 may be configured (e.g., based on the received SIB 724) to refrain from transmitting a report indicating detection of the RLF (e.g., based on an indication of the time period T₁ of the feeder link switch over 730 included in the SIB 724). In another example, the UE may be configured (e.g., based on the received SIB 724) to refrain from RLF detection during a time period that is contemporaneous with the time period T₁ of the feeder link switch over 730.

At operation 1008, the UE may be configured to establish a connection associated with the target NTN entity based on the time period. The UE may establish the connection with the target NTN entity based on the time period T₁+x at which the target NTN entity is available following the feeder link switch over, which may be indicated in the received message indicating the switch over.

In some aspects, the UE may establish a connection associated with the target NTN entity by reestablishing an RRC connection with the NTN. For example, the UE may be configured to transmit an RRC Connection Reestablishment request to the target NTN entity based on the time period (e.g., the time period T₁+x), and the UE may be configured to reestablish the connection associated with the target NTN entity based on the RRC Connection Reestablishment request. The UE may receive an RRC Connection Reestablishment Complete message from the target NTN entity, which may indicate that a bearer has been allocated to the UE and the UE is (re)connected with the NTN through the target NTN entity.

In some other aspects, the UE may establish a connection associated with the target NTN entity by attaching to the target NTN entity. For example, the UE may synchronize with the target NTN entity, such as by acquiring the MIB and/or one or more SIBs transmitted by the target NTN entity, by performing a RACH procedure with the target NTN entity, etc.

In still other aspects, the UE may establish a connection associated with the target NTN entity by transmitting an RRC Connection request to the target NTN entity. The UE may receive an RRC Connection Setup message from the target NTN entity in response to the RRC Connection request. Based on the RRC Connection Setup message, the UE may transmit an RRC Connection Setup Complete message to the target NTN entity.

In yet further aspects, the UE may establish a connection associated with the target NTN entity by receiving an RRC Connection Reconfiguration message from the target NTN entity. The RRC Connection Reconfiguration message may be used to configure one or more logical, transport, and/or physical channel between the UE and the target NTN entity. Additionally or alternatively, the RRC Connection Reconfiguration message may be used to establish or modify one or more radio bearers for the UE through the target NTN entity.

In some aspects, the connection may be established further based on the information associated with the target NTN entity. For example, the information associated with the target NTN entity may include redirection information included in an RRC Connection Release message with the redirection information. The UE may decode or parse the redirection information to obtain a carrier frequency, ARFCN, SSB subcarrier spacing, SSB measurement and timing configuration, and/or other information that may be used, alone or in the aggregate with other information, to identify the target NTN entity and/or to operate on a cell provided by the target NTN entity.

In some aspects, the UE may establish a connection associated with the target NTN entity further based on a conditional handover of the UE from the source NTN entity to the target NTN entity when a configuration associated with the conditional handover has been received from the source NTN entity. The conditional handover configuration may indicate a set of conditions that are to be met in order for the UE to initiate a handover procedure from the source NTN entity to the target NTN entity. For example, the configuration may indicate the time period T₁ at which the feeder link switch over 730 is to occur, which may result in the source NTN entity becoming unavailable to the UE for connectivity. Therefore, when the UE detects the condition that a clock time (or current time) is equal to the time period T₁ (or within a threshold margin of the time period T₁), the UE may initiate the conditional handover procedure from the source NTN entity to the target NTN entity.

In the context of FIG. 7, operation 1008 may be illustrated by the UE 704 transmitting the RRC Connection Reestablishment request 734 at the time period T₁+x at which the target gNB 702b is available following the feeder link switch over 730. The UE 704 may receive an RRC Connection Reestablishment Complete message from the target gNB 702b based on the request 734.

In the context of FIG. 8, operation 1008 may be illustrated by the UE 804 synchronizing 832 to the target gNB 802b. In some aspects, the UE 804 may acquire a MIB and/or SIB(s) from the target gNB 802b and/or the UE 804 may perform a RACH procedure with the target gNB 802b in order to synchronize 832 with the target gNB 802b.

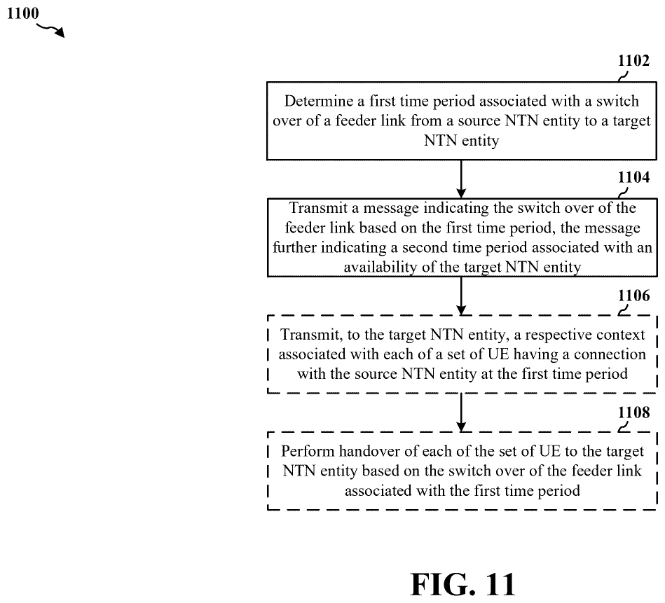

FIG. 11 is a flowchart of a method 1100 of wireless communication. The method 1100 may be performed by or at a network entity (e.g., the base station 102/180, 310), another wireless communications apparatus, or one or more components thereof. For example, the method 1100 may be performed by or at a source NTN entity. According to various different aspects, one or more of the illustrated blocks of the method 1100 may be omitted, transposed, and/or contemporaneously performed.

At operation 1102, the source NTN entity may be configured to determine a first time period associated with a switch over of a feeder link from the source NTN entity to a target NTN entity. In some aspects, the source NTN entity may be notified of the time period T₁ at which the feeder link switch over will occur. For example, the source NTN entity may be notified by a gateway or other similar network entity configured to communicate with the source NTN entity. In some further aspects, the source NTN entity may be further notified of a target NTN entity to which a set of UEs connected with the source NTN entity at time period T₁ will be connected at another time period T₁+x following the feeder link switch over. For example, the source NTN entity may be notified of a cell ID (e.g., PCI) of the target NTN entity, a carrier frequency of the target NTN entity, an ARFCN of the target NTN entity, a subcarrier spacing of SSBs transmitted by the target NTN entity, an smtc configuration associated with the target NTN entity, and/or other redirection information that may be used by a UE to identify the target NTN entity and/or operate on a cell provided by the target NTN entity.

In the context of FIG. 7, operation 1102 may be illustrated by the source gNB 702 a determining the time period T₁ at which the feeder link switch over 730 occurs (or is to occur). In the context of FIG. 8, operation 1102 may be illustrated by the source gNB 802a determining the time period T₁ at which the feeder link switch over 830 occurs (or is to occur). For example, the source gNB 802 a may be notified of an impending (hard) switch over of a feeder link at time period T₁. The source gNB 802a may be further notified of the next available target gNB 802b.

At operation 1104, the source NTN entity may be configured to transmit a message indicating the switch over of the feeder link based on the first time period, the message further indicating a second time period associated with an availability of the target NTN entity. In some aspects, the message includes one of a SIB or a RRC Connection Release message. For example, a SIB may include one of a SIB3 or a SIB19. In some aspects, an RRC Connection Release message may include redirection information identifying the target NTN entity. In some aspects, the message further includes an indication that the switch over is associated with an RLF. Such an indication that the switch over is associated with an RLF may prevent UEs from reporting RLFs that may occur contemporaneously with the feeder link switch over.

In the context of FIG. 7, operation 1104 may be illustrated by the source gNB 702a transmitting the SIB 724. For example, the source gNB 702a may broadcast the SIB 724 in a cell provided by the source gNB 702a.

In the context of FIG. 8, operation 1104 may be illustrated by the source gNB 802a transmitting the RRC Connection Release message 824. The RRC Connection Release message 824 may include redirection information. For example, the source gNB 802a may be notified of a (hard) switch over of a feeder link at a time period T₁, as well as the target gNB 802b that will be available after the feeder link switch over 830. The source gNB 802a may include information indicating the target gNB 802b and the time period T₁+x at which the target gNB 802b will become available, which may be an offset x from the reference time period T₁ at which the feeder link switch over 830 occurs.

Referring to FIG. 9, the redirection information 910 may indicate an ARFCN of the target gNB 802b, a subcarrier spacing of SSBs transmitted by the target gNB 802b, and/or an SSB measurement and timing configuration associated with the target gNB 802b, some or all of which may be used by a UE to identify the target gNB 802b and/or operate on a cell provided by the target gNB 802b. The redirection information 910 may further indicate an availability time 920 at which the target gNB 802b is available after feeder link switch over. The availability time may be indicated as a reference time (e.g., the feeder link switch over time period T₁), to which an offset x may be added.

At 1106, in some optional aspects, the source NTN entity may be configured to transmit, to the target NTN entity, a respective context associated with each of a set of UE having a connection with the source NTN entity at the first time period. The source NTN entity may transmit the UE context(s) over an Xn interface. For example, the source NTN entity may transmit the UE context(s) using an XnAP control protocol.

In the context of FIG. 7, operation 1106 may be illustrated by the source gNB 702a performing the UE context transfer 728. During the UE context transfer 728, the source gNB 702a may transmit, to the target gNB 702b a respective UE context for each of the UEs connected to the source gNB 702a at the time period Ti or at a time period preceding the time period T₁.

At 1108, in some optional aspects, the source NTN entity may be configured to perform handover of each of a set of UE to the target NTN entity based on the switch over of the feeder link associated with the first time period. For example, the source NTN entity may transmit a handover request to the target NTN entity, and based thereon, the source NTN entity may receive a handover request acknowledgement from the target NTN entity. The source NTN entity may further transmit a sequence number (SN) status transfer message to the target NTN entity, e.g., following reception of the handover request acknowledgement. In some aspects, the source NTN entity may be configured to transmit, to at least one of the set of UE, a configuration associated with conditional handover to the target NTN entity, and the at least one of the set of UE may be handed over to the target NTN entity based on the configuration.

In the context of FIG. 7, operation 1108 may be illustrated by the source gNB 702a performing handover of the UE 704 to the target gNB 702b based on the feeder link switch over 730 at time period T₁. In the context of FIG. 8, operation 1108 may be illustrated by the source gNB 802a performing handover of the UE 804 to the target gNB 802 b based on the feeder link switch over 830 at time period T₁.

In some aspects, the source NTN entity may transmit an RRC Connection Release message (e.g., before or during the handover procedure or without performing the handover procedure). The RRC Connection Release message may be an RRC Connection Release with Redirection message that includes redirection information associated with the target NTN entity. For example, the source NTN entity may be notified of a (hard or soft) switch over of a feeder link at a time period T₁, as well as information associated with the target NTN entity that will be available after the feeder link switch over. The source NTN entity may include information indicating the target NTN entity, the time period T₁, and/or the time period T₁+x at which the target NTN entity will become available.

The redirection information may indicate one or more of a cell ID (e.g., PCI) of the target NTN entity, carrier frequency of the target NTN entity, an ARFCN of the target NTN entity, a subcarrier spacing of SSBs transmitted by the target NTN entity, and/or an SSB measurement and timing configuration associated with the target NTN entity, some or all of which may be used by a UE to identify the target NTN entity and/or operate on a cell provided by the target NTN entity. The redirection information may further indicate an availability time at which the target NTN entity is available after feeder link switch over. The availability time may be indicated as a reference time (e.g., the feeder link switch over time period T₁), to which an offset x may be added.

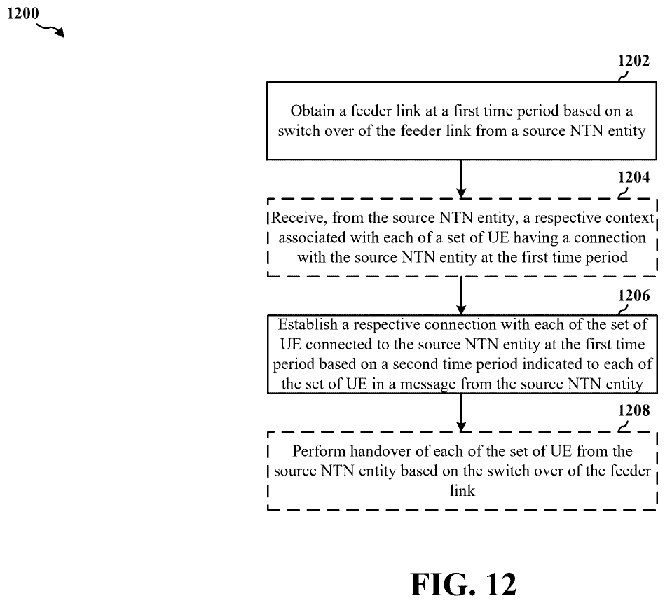

FIG. 12 is a flowchart of a method 1200 of wireless communication. The method 1200 may be performed by or at a network entity (e.g., the base station 102/180, 310), another wireless communications apparatus, or one or more components thereof. For example, the method 1200 may be performed by or at a target NTN entity. According to various different aspects, one or more of the illustrated blocks may be omitted, transposed, and/or contemporaneously performed.

At operation 1202, the target NTN entity may be configured to obtain a feeder link at a first time period based on a switch over of the feeder link from a source NTN entity. For example, the target NTN entity may receive information indicating a set of satellites that may supply a feeder link to the target NTN entity. The target NTN entity may connect with one of the set of satellites, for example, once the one of the set of satellites has reached a switch over threshold at a time period T₁.

In the context of FIG. 4, operation 1202 may be illustrated by the gNB2 402b obtaining the feeder link 414b from the NTN payload 410 through GW2 406b. In the context of FIG. 5, operation 1202 may be illustrated by the gNB2 502b obtaining the feeder link 514b from the NTN payload 510 through GW2 506b. In the context of FIG. 6, operation 1202 may be illustrated by the gNB2 602b obtaining the second feeder link 614b from the NTN payload 610 through GW2 606b.

At operation 1204, in some optional aspects, the target NTN entity may receive, from a source NTN entity, a respective UE context associated with each of a set of UE. Each of the set of UE may have a connection with the source NTN entity at the first time period. The target NTN entity may receive the UE context(s) over an Xn interface. For example, the target NTN entity may receive the UE context(s) using an XnAP control protocol.

In the context of FIG. 7, operation 1204 may be illustrated by the target gNB 702b receiving the UE context transfer 728 from the source gNB 702a. During the UE context transfer 728, the target gNB 702b may receive, from the source gNB 702a, a respective UE context for each of the UEs connected to the source gNB 702a at the time period T₁ or at a time preceding the time period T₁.

At operation 1206, the target NTN entity may be configured to establish a respective connection with each of the set of UE connected to the source NTN entity at the first time period based on a second time period indicated to each of the set of UE in a message from the source NTN entity. In some aspects, the message includes one of a SIB or a RRC Connection Release message. In some aspects, the SIB includes one of a SIB3 or a SIB19. In some aspects, the RRC Connection Release message includes redirection information identifying the target NTN entity.

In some aspects, establishment of a respective connection with each of the set of UE handed over from the source NTN entity based on the second time period indicated to each of the set of the UE in the message from the source NTN entity includes to: receive, from each of the set of UE, a respective request for RRC connection reestablishment based on the second time period; and reestablish the respective connection with each of the set of UE based on the respective request.

In some other aspects, the UE may establish a connection associated with the target NTN entity by synchronizing with the target NTN entity, such as by acquiring the MIB and/or one or more SIBs transmitted by the target NTN entity, by performing a RACH procedure with the target NTN entity, etc.

In still other aspects, establishment of a respective connection with each of the set of UE handed over from the source NTN entity based on the second time period indicated to each of the set of the UE in the message from the source NTN entity includes to: receive a respective RRC Connection request from each of the set of UE, transmit a respective RRC Connection Setup message to each of the set of UE in response to the respective RRC Connection request, and receive a respective RRC Connection Setup Complete message from each of the set of UE based on the respective RRC Connection Setup message.

In yet further aspects, establishment of a respective connection with each of the set of UE handed over from the source NTN entity based on the second time period indicated to each of the set of the UE in the message from the source NTN entity includes to: transmit a respective RRC Connection Reconfiguration message to each of the set of UE. The RRC Connection Reconfiguration message may be used to configure one or more logical, transport, and/or physical channel between the UE and the target NTN entity. Additionally or alternatively, the RRC Connection Reconfiguration message may be used to establish or modify one or more radio bearers for the UE through the target NTN entity.

In the context of FIG. 7, operation 1206 may be illustrated by the target gNB 702b receiving, from the UE 704, the RRC Connection Reestablishment request 734 at the time period T₁+x at which the target gNB 702b is available following the feeder link switch over 730. The target gNB 702b may transmit an RRC Connection Reestablishment Complete message to the UE 704 based on the request 734.

In the context of FIG. 8, operation 1206 may be illustrated by the target gNB 802b being synchronized 832 with by the UE 804 at the time period T₁+x at which the target gNB 802b is available following the feeder link switch over 830. In some aspects, the target gNB 802b may perform a RACH procedure with the UE 804 in order for the UE 804 to synchronize 832 with target gNB 802b.

At operation 1208, in some optional aspects, the target NTN entity may be configured to perform handover of each of the set of UE from the source NTN entity based on the switch over of the feeder link. In some aspects, the handover may be based on a configuration associated with conditional handover from the source NTN entity, and at least one of the set of UE may be handed over from the source NTN entity based on the configuration. For example, the target NTN entity may receive a handover request from the source NTN entity, and based thereon, the target NTN entity may transmit a handover request acknowledgement to the source NTN entity. The target NTN entity may further receive an SN status transfer message from the source NTN entity, e.g., following transmission of the handover request acknowledgement.

In the context of FIG. 7, operation 1208 may be illustrated by the target gNB 702b performing handover of the UE 704 from the source gNB 702a (e.g., at the target gNB availability time period T₁+x) based on the feeder link switch over 730 at time period T₁. In the context of FIG. 8, operation 1208 may be illustrated by the target gNB 802b performing handover of the UE 804 from the source gNB 802a (e.g., at the target gNB availability time period T₁+x) based on the feeder link switch over 830 at time period T₁.

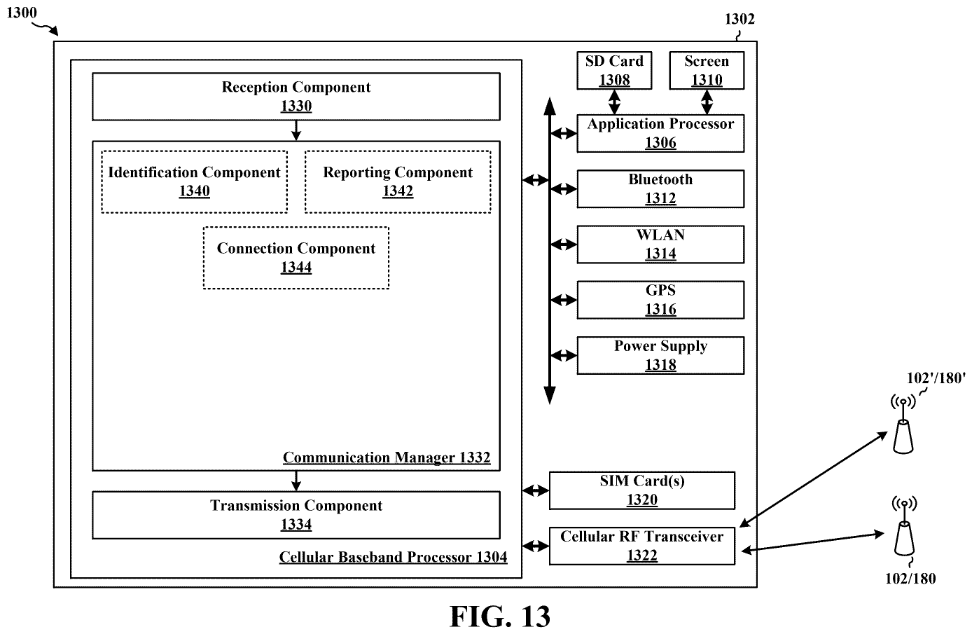

FIG. 13 is a diagram 1300 illustrating an example of a hardware implementation for an apparatus 1302. The apparatus 1302 may be a UE or similar device, or the apparatus 1302 may be a component of a UE or similar device. The apparatus 1302 may include a cellular baseband processor 1304 (also referred to as a modem) and/or a cellular RF transceiver 1322, which may be coupled together and/or integrated into the same package, component, circuit, chip, and/or other circuitry.

In some aspects, the apparatus 1302 may accept or may include one or more subscriber identity modules (SIM) cards 1320, which may include one or more integrated circuits, chips, or similar circuitry, and which may be removable or embedded. The one or more SIM cards 1320 may carry identification and/or authentication information, such as an international mobile subscriber identity (IMSI) and/or IMSI-related key(s). Further, the apparatus 1302 may include one or more of an application processor 1306 coupled to a secure digital (SD) card 1308 and a screen 1310, a Bluetooth module 1312, a wireless local area network (WLAN) module 1314, a Global Positioning System (GPS) module 1316, and/or a power supply 1318.

The cellular baseband processor 1304 communicates through the cellular RF transceiver 1322 with the UE 104 and/or base station 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304.

In the context of FIG. 4, the cellular baseband processor 1304 may be a component of the UE 450 and may include the memory 460 and/or at least one of the TX processor 468, the RX processor 456, and/or the controller/processor 459. In one configuration, the apparatus 1302 may be a modem chip and/or may be implemented as the baseband processor 1304, while in another configuration, the apparatus 1302 may be the entire UE (e.g., the UE 450 of FIG. 4) and may include some or all of the abovementioned components, circuits, chips, and/or other circuitry illustrated in the context of the apparatus 1302. In one configuration, the cellular RF transceiver 1322 may be implemented as at least one of the transmitter 454TX and/or the receiver 454RX.

The reception component 1330 may be configured to receive signaling on a wireless channel, such as signaling from a base station 102/180 or UE 104. The transmission component 1334 may be configured to transmit signaling on a wireless channel, such as signaling to a base station 102/180 or UE 104. The communication manager 1332 may coordinate or manage some or all wireless communications by the apparatus 1302, including across the reception component 1330 and the transmission component 1334.

The reception component 1330 may provide some or all data and/or control information included in received signaling to the communication manager 1332, and the communication manager 1332 may generate and provide some or all of the data and/or control information to be included in transmitted signaling to the transmission component 1334. The communication manager 1332 may include the various illustrated components, including one or more components configured to process received data and/or control information, and/or one or more components configured to generate data and/or control information for transmission.

The communication manager 1332 may include an identification component 1340, a reporting component 1342, and a connection component 1344. The reception component 1330 may be configured to receive, in an NTN, a message indicating a feeder link switch over from a source NTN entity 102/180 102/180 to a target NTN entity 102′/180′ and a time period associated with the switch over, e.g., as described in connection with 1002 of FIG. 10. In some aspects, the message includes one of a SIB or a RRC Connection Release message. In some aspects, the SIB includes one of a SIB3 or a SIB19. In some aspects, the RRC Connection Release message includes redirection information, and the connection may be established further based on the redirection information.

The identification component 1340 may be configured to identify the target NTN entity 102′/180′ based on information associated with the target NTN entity 102′/180′ included in the message, e.g., as described in connection with 1004 of FIG. 10. For example, the identification component 1340 may decode the received message to obtain information indicating one or more of a carrier frequency of the target NTN entity 102′/180′, an ARFCN of the target NTN entity 102′/180′, a subcarrier spacing of SSBs transmitted by the target NTN entity 102′/180′, and/or an SSB measurement and timing configuration associated with the target NTN entity 102′/180′. The identification component 1340 may tune receiver circuitry (e.g., circuitry of an RF front end and/or circuitry of a PHY layer) to the carrier frequency and/or ARFCN of the target NTN entity 102′/180′.

The reporting component 1342 may be configured to refrain from reporting an RLF associated with the source NTN entity 102/180 based on the message, e.g., as described in connection with 1006 of FIG. 10. The message may indicate, to the reporting component 1342, that a feeder link switch over is to occur. If the feeder link switch over is a hard switch over at time period T₁, then the apparatus 1302 may (temporarily) lose connectivity to the NTN at time period T₁. In one example, the reporting component 1342 may refrain from reporting the RLF based on the indication that the switch over is associated with the RLF. In some aspects, to refrain from reporting the RLF, the reporting component 1342 may be configured to detect the RLF associated with the source NTN entity 102/180, but may be configured (e.g., based on the received message) to refrain from reporting the RLF. In some other aspects, to refrain from reporting the RLF, the reporting component 1342 may be configured (e.g., based on the received message) to refrain from detecting for RLFs during a time period that is contemporaneous with the time period T₁ of the feeder link switch over.

The connection component 1344 may be configured to establish a connection associated with the target NTN entity 102′/180′ based on the time period, e.g., as described in connection with 1008 of FIG. 10. The connection component 1344 may establish the connection with the target NTN entity 102′/180′ based on the time period T₁+x at which the target NTN entity 102′/180′ is available following the feeder link switch over, which may be indicated in the received message indicating the switch over.

In some aspects, the connection component 1344 may establish a connection associated with the target NTN entity 102′/180′ by reestablishing an RRC connection with the NTN. For example, the transmission component 1334 may be configured to transmit an RRC Connection Reestablishment request to the target NTN entity 102′/180′ based on the time period (e.g., the time period T₁+x), and the connection component 1344 may be configured to reestablish the connection associated with the target NTN entity 102′/180′ based on the RRC Connection Reestablishment request. The reception component 1330 may receive an RRC Connection Reestablishment Complete message from the target NTN entity 102′/180′, which may indicate that a bearer has been allocated to the apparatus 1302 and the apparatus 1302 is (re)connected with the NTN through the target NTN entity 102′/180′.

In some other aspects, the connection component 1344 may establish a connection associated with the target NTN entity 102′/180′ by attaching to the target NTN entity 102′/180′. For example, the connection component 1344 may synchronize with the target NTN entity 102′/180′, such as by acquiring the MIB and/or one or more SIBs transmitted by the target NTN entity 102′/180′, by performing a RACH procedure with the target NTN entity 102′/180′, etc.

In still other aspects, the connection component 1344 may establish a connection associated with the target NTN entity 102′/180′ by transmitting an RRC Connection request to the target NTN entity 102′/180′. The reception component 1330 may receive an RRC Connection Setup message from the target NTN entity 102′/180′ in response to the RRC Connection request. Based on the RRC Connection Setup message, the transmission component 1334 may transmit an RRC Connection Setup Complete message to the target NTN entity 102′/180′.

In yet further aspects, the connection component 1344 may establish a connection associated with the target NTN entity 102′/180′ by receiving an RRC Connection Reconfiguration message from the target NTN entity 102′/180′. The RRC Connection Reconfiguration message may be used to configure one or more logical, transport, and/or physical channel between the apparatus 1302 and the target NTN entity 102′/180′. Additionally or alternatively, the RRC Connection Reconfiguration message may be used to establish or modify one or more radio bearers for the apparatus 1302 through the target NTN entity 102′/180′.

In some aspects, the connection may be established further based on the information associated with the target NTN entity 102′/180′. For example, the information associated with the target NTN entity 102′/180′ may include redirection information included in an RRC Connection Release message with the redirection information. The connection component 1344 may decode or parse the redirection information to obtain a carrier frequency, ARFCN, SSB subcarrier spacing, SSB measurement and timing configuration, and/or other information that may be used, alone or in the aggregate with other information, to identify the target NTN entity 102′/180′ and/or to operate on a cell provided by the target NTN entity 102′/180′.

In some aspects, the connection component 1344 may establish a connection associated with the target NTN entity 102′/180′ further based on a conditional handover of the apparatus 1302 from the source NTN entity 102/180 to the target NTN entity 102′/180′ when a configuration associated with the conditional handover has been received from the source NTN entity 102/180. The conditional handover configuration may indicate a set of conditions that are to be met in order for the connection component 1344 to initiate a handover procedure from the source NTN entity 102/180 to the target NTN entity 102′/180′. For example, the configuration may indicate the time period T₁ at which the feeder link switch over 730 is to occur, which may result in the source NTN entity 102/180 becoming unavailable to the connection component 1344 for connectivity. Therefore, when the connection component 1344 detects the condition that a clock time (or current time) is equal to the time period T₁ (or within a threshold margin of the time period T₁), the connection component 1344 may initiate the conditional handover procedure from the source NTN entity 102/180 to the target NTN entity 102′/180′.

The apparatus 1302 may include additional components that perform some or all of the blocks, operations, signaling, etc. of the algorithm(s) in the aforementioned call flow diagram(s) and/or flowchart(s) of FIGS. 7, 8, and/or 10. As such, some or all of the blocks, operations, signaling, etc. in the aforementioned call flow diagram(s) and/or flowchart(s) of FIGS. 7, 8, and/or 10 may be performed by one or more components and the apparatus 1302 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the cellular baseband processor 1304, includes means for receiving, in a NTN, a message indicating a feeder link switch over from a source NTN entity to a target NTN entity and a time period associated with the switch over; and means for establishing a connection associated with the target NTN entity based on the time period.

In one configuration, the message includes one of a SIB or a RRC Connection Release message.

In one configuration, the SIB includes one of a SIB3 or a SIB19.

In one configuration, the RRC Connection Release message includes redirection information, and the connection is established further based on the redirection information.

In one configuration, the apparatus 1302, and in particular the cellular baseband processor 1304, may further include means for identifying the target NTN entity based on information associated with the target NTN entity included in the message, and the connection is established further based on the information associated with the target NTN entity.

In one configuration, the time period includes at least one of a first time period at which the switch over occurs or a second time period at which the target NTN entity is available for establishing the connection, the second time period being offset from the first time period.

In one configuration, the means for establishing the connection associated with the target NTN entity based on the time period is configured to transmit a request for RRC connection reestablishment to the target NTN entity based on the time period; and reestablish the connection associated with the target NTN entity based on the request.

In one configuration, the apparatus 1302, and in particular the cellular baseband processor 1304, may further include means for refraining from reporting a RLF associated with the source NTN entity based on the message.

In one configuration, the message further includes an indication that the switch over is associated with the RLF, and the refraining from reporting the RLF is based on the indication that the switch over is associated with the RLF.

In one configuration, the means for refraining from reporting the RLF is configured to detect the RLF associated with the source NTN entity; and refrain from transmitting a report indicating the RLF based on the message.

In one configuration, the means for refraining from reporting the RLF is configured to refrain from detecting for the RLF associated with the source NTN entity based on the message.

In one configuration, the connection is established further based on a conditional handover of the UE from the source NTN entity to the target NTN entity when a configuration associated with the conditional handover has been received from the source NTN entity.

The aforementioned means may be one or more of the aforementioned components of the apparatus 1302 configured to perform the functions recited by the aforementioned means. As described supra, the apparatus 1302 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

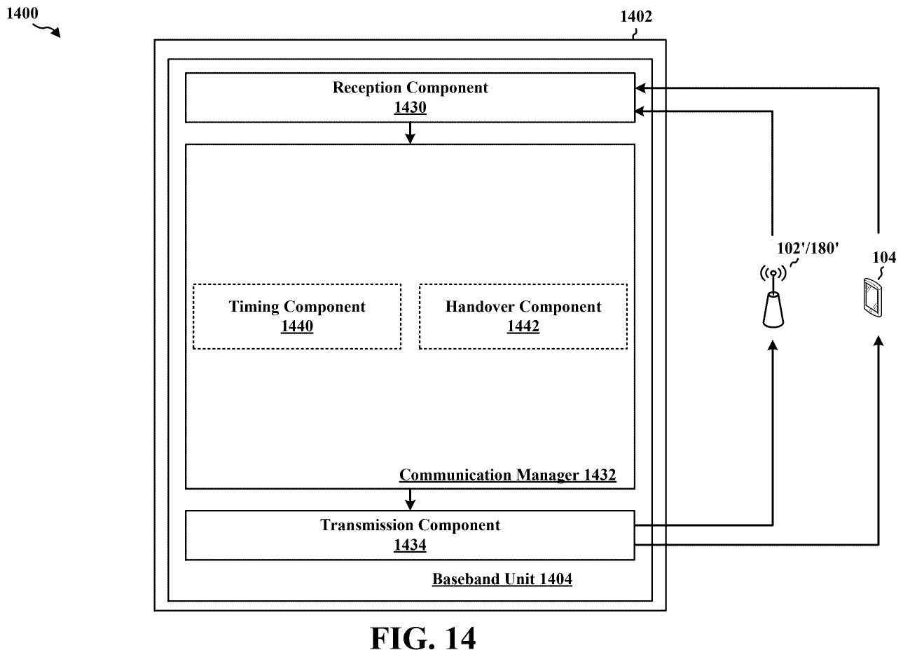

FIG. 14 is a diagram 1400 illustrating an example of a hardware implementation for an apparatus 1402. The apparatus 1402 may be a base station or similar device or system, or the apparatus 1402 may be a component of a base station or similar device or system. The apparatus 1402 may include a baseband unit 1404. The baseband unit 1404 may communicate through a cellular RF transceiver. For example, the baseband unit 1404 may communicate through a cellular RF transceiver with a UE 104, such as for downlink and/or uplink communication, and/or with a base station 102/180, such as for IAB.

The baseband unit 1404 may include a computer-readable medium/memory, which may be non-transitory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 410 and may include the memory 476 and/or at least one of the TX processor 416, the RX processor 470, and the controller/processor 475.

The reception component 1430 may be configured to receive signaling on a wireless channel, such as signaling from a UE 104 or base station 102/180. The transmission component 1434 may be configured to transmit signaling on a wireless channel, such as signaling to a UE 104 or base station 102/180. The communication manager 1432 may coordinate or manage some or all wireless communications by the apparatus 1402, including across the reception component 1430 and the transmission component 1434.

The reception component 1430 may provide some or all data and/or control information included in received signaling to the communication manager 1432, and the communication manager 1432 may generate and provide some or all of the data and/or control information to be included in transmitted signaling to the transmission component 1434. The communication manager 1432 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1432 may include a timing component 1440 and a handover component 1442. The timing component 1440 may be configured to determine a first time period associated with a switch over of a feeder link from the apparatus 1402 to a target NTN entity 102′/180′, e.g., as described in connection with 1102 of FIG. 11. In some aspects, the timing component 1440 entity may be notified of the time period T₁ at which the feeder link switch over will occur. For example, the timing component 1440 may be notified by a gateway or other similar network entity configured to communicate with the apparatus 1402. In some further aspects, the timing component 1440 may be further notified of a target NTN entity 102′/180′ to which a set of UE 104 s connected with the apparatus 1402 at time period T₁ will be connected at another time period T₁+x following the feeder link switch over. For example, the timing component 1440 may be notified of a cell ID (e.g., PCI) of the target NTN entity 102′/180′, a carrier frequency of the target NTN entity 102′/180′, an ARFCN of the target NTN entity 102′/180′, a subcarrier spacing of SSBs transmitted by the target NTN entity 102′/180′, an smtc configuration associated with the target NTN entity 102′/180′, and/or other redirection information that may be used by a UE 104 to identify the target NTN entity 102′/180′ and/or operate on a cell provided by the target NTN entity 102′/180′.

The transmission component 1434 may be configured to transmit a message indicating the switch over of the feeder link based on the first time period, the message further indicating a second time period associated with an availability of the target NTN entity 102′/180′, e.g., as described in connection with 1104 of FIG. 11. In some aspects, the message includes one of a SIB or a RRC Connection Release message. For example, a SIB may include one of a SIB3 or a SIB19. In some aspects, an RRC Connection Release message may include redirection information identifying the target NTN entity 102′/180′. In some aspects, the message further includes an indication that the switch over is associated with an RLF. Such an indication that the switch over is associated with an RLF may prevent UE 104s from reporting RLFs that may occur contemporaneously with the feeder link switch over.

The transmission component 1434 may be configured to transmit, to the target NTN entity 102′/180′, a respective context associated with each of a set of UE 104 having a connection with the apparatus 1402 at the first time period, e.g., as described in connection with 1106 of FIG. 11. The transmission component 1434 may transmit the UE 104 context(s) over an Xn interface. For example, the transmission component 1434 may transmit the UE 104 context(s) using an XnAP control protocol.

The handover component 1442 may be configured to perform handover of each of a set of UE 104 to the target NTN entity 102′/180′ based on the switch over of the feeder link associated with the first time period, e.g., as described in connection with 1108 of FIG. 11. For example, the transmission component 1434 may transmit a handover request to the target NTN entity 102′/180′, and based thereon, the reception component 1430 may receive a handover request acknowledgement from the target NTN entity 102′/180′. The transmission component 1434 may further transmit a sequence number (SN) status transfer message to the target NTN entity 102′/180′, e.g., following reception of the handover request acknowledgement. In some aspects, the transmission component 1434 may be configured to transmit, to at least one of the set of UE 104, a configuration associated with conditional handover to the target NTN entity 102′/180′, and the at least one of the set of UE 104 may be handed over to the target NTN entity 102′/180′ based on the configuration.

In some aspects, the transmission component 1434 may transmit an RRC Connection Release message (e.g., before or during the handover procedure or without performing the handover procedure). The RRC Connection Release message may be an RRC Connection Release with Redirection message that includes redirection information associated with the target gNB. For example, the handover component 1442 may be notified of a (hard or soft) switch over of a feeder link at a time period T₁, as well as information associated with the target NTN entity 102′/180′ that will be available after the feeder link switch over. The handover component 1442 may include information indicating the target gNB, the time period T₁, and/or the time period T₁+x at which the target gNB will become available.

The redirection information may indicate one or more of a cell ID (e.g., PCI) of the target NTN entity 102′/180′, carrier frequency of the target NTN entity 102′/180′, an ARFCN of the target NTN entity 102′/180′, a subcarrier spacing of SSBs transmitted by the target NTN entity 102′/180′, and/or an SSB measurement and timing configuration associated with the target NTN entity 102′/180′, some or all of which may be used by a UE 104 to identify the target NTN entity 102′/180′ and/or operate on a cell provided by the target NTN entity 102′/180′. The redirection information may further indicate an availability time at which the target NTN entity 102′/180′ is available after feeder link switch over. The availability time may be indicated as a reference time (e.g., the feeder link switch over time period T₁), to which an offset x may be added.

The apparatus 1402 may include additional components that perform some or all of the blocks, operations, signaling, etc. of the algorithm(s) in the aforementioned call flow diagram(s) and/or flowchart(s) of FIGS. 7, 8, and/or 11. As such, some or all of the blocks, operations, signaling, etc. in the aforementioned call flow diagram(s) and/or flowchart(s) of FIGS. 7, 8, and/or 11 may be performed by a component and the apparatus 1402 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the baseband unit 1404, includes means for determining a first time period associated with a switch over of a feeder link from the source NTN entity to a target NTN entity; and means for transmitting a message indicating the switch over of the feeder link based on the first time period, the message further indicating a second time period associated with an availability of the target NTN entity.

In one configuration, the message includes one of a SIB or a RRC Connection Release message.

In one configuration, the SIB includes one of a SIB3 or a SIB19.

In one configuration, the RRC Connection Release message includes redirection information identifying the target NTN entity.

In one configuration, the apparatus 1402, and in particular the baseband unit 1404, may further include means for transmitting, in a single message to the target NTN entity, a respective context associated with each of a set of UE having a connection with the source NTN entity at the first time period.

In one configuration, the apparatus 1402, and in particular the baseband unit 1404, may further include means for performing, before the second time period, handover of each of a set of UE to the target NTN entity based on the switch over of the feeder link associated with the first time period.

In one configuration, the apparatus 1402, and in particular the baseband unit 1404, may further include means for transmitting, to at least one of the set of UE, a configuration associated with conditional handover to the target NTN entity, and the at least one of the set of UE is handed over to the target NTN entity based on the configuration.

In one configuration, the second time period is offset from the first time period.

In one configuration, the message further includes an indication that the switch over is associated with a RLF.

The aforementioned means may be one or more of the aforementioned components of the apparatus 1402 configured to perform the functions recited by the aforementioned means. As described supra, the apparatus 1402 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

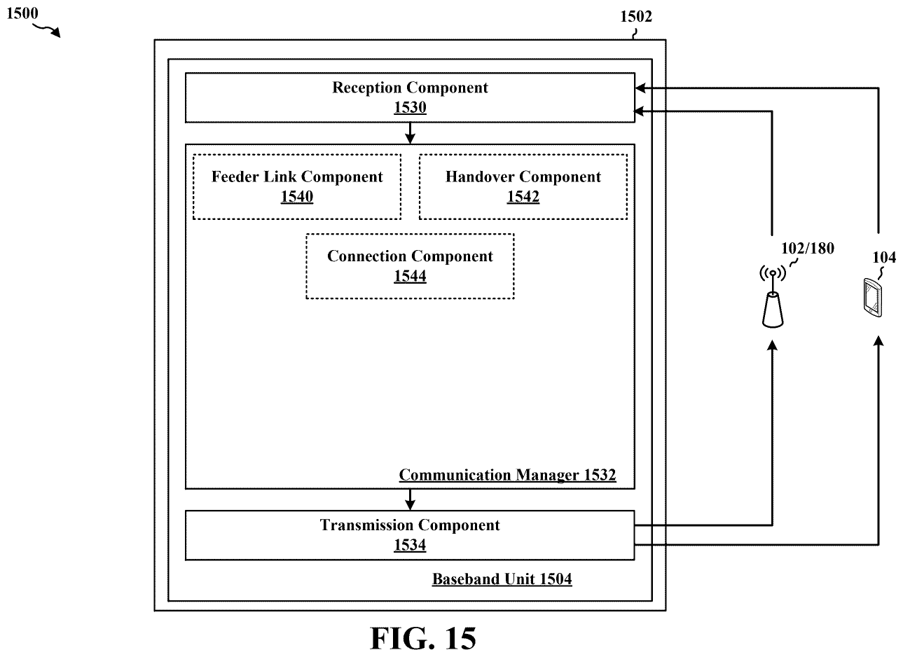

FIG. 15 is a diagram 1500 illustrating an example of a hardware implementation for an apparatus 1502. The apparatus 1502 may be a base station or similar device or system, or the apparatus 1502 may be a component of a base station or similar device or system. The apparatus 1502 may include a baseband unit 1504. The baseband unit 1504 may communicate through a cellular RF transceiver. For example, the baseband unit 1504 may communicate through a cellular RF transceiver with a UE 104, such as for downlink and/or uplink communication, and/or with a base station 102/180, such as for IAB.

The baseband unit 1504 may include a computer-readable medium/memory, which may be non-transitory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 410 and may include the memory 476 and/or at least one of the TX processor 416, the RX processor 470, and the controller/processor 475.

The reception component 1530 may be configured to receive signaling on a wireless channel, such as signaling from a UE 104 or base station 102/180. The transmission component 1534 may be configured to transmit signaling on a wireless channel, such as signaling to a UE 104 or base station 102/180. The communication manager 1532 may coordinate or manage some or all wireless communications by the apparatus 1502, including across the reception component 1530 and the transmission component 1534.

The reception component 1530 may provide some or all data and/or control information included in received signaling to the communication manager 1532, and the communication manager 1532 may generate and provide some or all of the data and/or control information to be included in transmitted signaling to the transmission component 1534. The communication manager 1532 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1532 may include a feeder link component 1540, a handover component 1542, and a connection component 1544. The feeder link component 1540 may be configured to obtain a feeder link at a first time period based on a switch over of the feeder link from a source NTN entity 102/180, e.g., as described in connection with 1202 of FIG. 12. For example, the feeder link component 1540 may receive information indicating a set of satellites that may supply a feeder link to the apparatus 1502. The feeder link component 1540 may connect with one of the set of satellites, for example, once the one of the set of satellites has reached a switch over threshold at a time period T₁.

The reception component 1530 may receive, from a source NTN entity 102/180, a respective UE 104 context associated with each of a set of UE 104, e.g., as described in connection with 1204 of FIG. 12. Each of the set of UE 104 may have a connection with the source NTN entity 102/180 at the first time period. The reception component 1530 may receive the UE 104 context(s) over an Xn interface. For example, the reception component 1530 may receive the UE 104 context(s) using an XnAP control protocol.

The connection component 1544 may be configured to establish a respective connection with each of the set of UE 104 connected to the source NTN entity 102/180 at the first time period based on a second time period indicated to each of the set of UE 104 in a message from the source NTN entity 102/180, e.g., as described in connection with 1206 of FIG. 12. In some aspects, the message includes one of a SIB or a RRC Connection Release message. In some aspects, the SIB includes one of a SIB3 or a SIB19. In some aspects, the RRC Connection Release message includes redirection information identifying the apparatus 1502.

In some aspects, establishment of a respective connection with each of the set of UE 104 handed over from the source NTN entity 102/180 based on the second time period indicated to each of the set of the UE 104 in the message from the source NTN entity 102/180 includes to: receive, from each of the set of UE 104, a respective request for RRC connection reestablishment based on the second time period; and reestablish the respective connection with each of the set of UE 104 based on the respective request.

In some other aspects, the UE 104 may establish a connection associated with the apparatus 1502 by synchronizing with the connection component 1544, such as by acquiring the MIB and/or one or more SIBs transmitted by the transmission component 1534, by performing a RACH procedure with the apparatus 1502, etc.

In still other aspects, establishment of a respective connection with each of the set of UE 104 handed over from the source NTN entity 102/180 based on the second time period indicated to each of the set of the UE 104 in the message from the source NTN entity 102/180 includes to: receive a respective RRC Connection request from each of the set of UE 104, transmit a respective RRC Connection Setup message to each of the set of UE 104 in response to the respective RRC Connection request, and receive a respective RRC Connection Setup Complete message from each of the set of UE 104 based on the respective RRC Connection Setup message.

In yet further aspects, establishment of a respective connection with each of the set of UE 104 handed over from the source NTN entity 102/180 based on the second time period indicated to each of the set of the UE 104 in the message from the source NTN entity 102/180 includes to: transmit a respective RRC Connection Reconfiguration message to each of the set of UE 104. The RRC Connection Reconfiguration message may be used to configure one or more logical, transport, and/or physical channel between the UE 104 and the apparatus 1502. Additionally or alternatively, the RRC Connection Reconfiguration message may be used to establish or modify one or more radio bearers for the UE 104 through the apparatus 1502.

The handover component 1542 may be configured to perform handover of each of the set of UE 104 from the source NTN entity 102/180 based on the switch over of the feeder link, e.g., as described in connection with 1208 of FIG. 12. In some aspects, the handover may be based on a configuration associated with conditional handover from the source NTN entity 102/180, and at least one of the set of UE 104 may be handed over from the source NTN entity 102/180 based on the configuration. For example, the handover component 1542 may receive a handover request from the source NTN entity 102/180, and based thereon, the handover component 1542 may transmit a handover request acknowledgement to the source NTN entity 102/180. The handover component 1542 may further receive an SN status transfer message from the source NTN entity 102/180, e.g., following transmission of the handover request acknowledgement.

The apparatus 1502 may include additional components that perform some or all of the blocks, operations, signaling, etc. of the algorithm(s) in the aforementioned call flow diagram(s) and/or flowchart(s) of FIGS. 7, 8, and/or 12. As such, some or all of the blocks, operations, signaling, etc. in the aforementioned call flow diagram(s) and/or flowchart(s) of FIGS. 7, 8, and/or 12 may be performed by a component and the apparatus 1502 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1502, and in particular the baseband unit 1504, includes means for obtaining a feeder link at a first time period based on a switch over of the feeder link from a source NTN entity; and means for establishing a respective connection with each of a set of UE connected with the source NTN entity at the first time period based on a second time period indicated to each of the set of UE in a message from the source NTN entity.

In one configuration, the apparatus 1502, and in particular the baseband unit 1504, may further include means for receiving, from the source NTN entity, a respective context associated with each of the set of UE, each of the set of UE having a connection with the source NTN entity at the first time period.

In one configuration, the contexts respectively associated with the set of UE are received in a single message from the source NTN entity.

In one configuration, the apparatus 1502, and in particular the baseband unit 1504, may further include means for communicating, over an Xn interface, information associated with a feeder link switch over from the source NTN entity to the target NTN entity.

In one configuration, the information associated with the feeder link switch over includes at least one of: the first time period at which the feeder link switch over occurs, the second time period at which the target NTN entity is available, or an indication of whether the feeder link switch over is associated with a radio link failure.

In one configuration, the apparatus 1502, and in particular the baseband unit 1504, may further include means for performing, before the second time period, handover of each of the set of UE from the source NTN entity based on the switch over of the feeder link.

In one configuration, the handover is based on a configuration associated with conditional handover from the source NTN entity, and at least one of the set of UE is handed over from the source NTN entity based on the configuration.

In one configuration, the second time period is offset from the first time period.

In one configuration, the means for establishing a respective connection with each of the set of UE handed over from the source NTN entity based on the second time period indicated to each of the set of the UE in the message from the source NTN entity is configured to receive, from each of the set of UE, a respective request for RRC connection reestablishment based on the second time period; and reestablish the respective connection with each of the set of UE based on the respective request.

The aforementioned means may be one or more of the aforementioned components of the apparatus 1502 configured to perform the functions recited by the aforementioned means. As described supra, the apparatus 1502 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following examples are illustrative only and may be combined with aspects of other embodiments or teachings described herein, without limitation.

Example 1 is an apparatus at a UE that is configured for: receiving, in a NTN, a message indicating a feeder link switch over from a source NTN entity to a target NTN entity and a time period associated with the switch over; and establishing a connection associated with the target NTN entity based on the time period.

Example 2 may be the apparatus of Example 1, and the message includes one of a SIB or a RRC Connection Release message.

Example 3 may be the apparatus of Example 2, and the SIB includes one of a SIB3 or a SIB19.

Example 4 may be the apparatus of Example 2, and the RRC Connection Release message includes redirection information, and the connection is established further based on the redirection information.

Example 5 may be the apparatus of Example 1, and being further configured for: identifying the target NTN entity based on information associated with the target NTN entity included in the message, and the connection is established further based on the information associated with the target NTN entity.

Example 6 may be the apparatus of Example 1, and the time period includes at least one of a first time period at which the switch over occurs or a second time period at which the target NTN entity is available for establishing the connection, the second time period being offset from the first time period.

Example 7 may be the apparatus of Example 1, and establishing the connection associated with the target NTN entity based on the time period includes: transmitting a request for RRC connection reestablishment to the target NTN entity based on the time period; and reestablishing the connection associated with the target NTN entity based on the request.

Example 8 may be the apparatus of Example 1, and being further configured for: refraining from reporting an RLF associated with the source NTN entity based on the message.

Example 9 may be the apparatus of Example 8, and the message further includes an indication that the switch over is associated with the RLF, and the refraining from reporting the RLF is based on the indication that the switch over is associated with the RLF.

Example 10 may be the apparatus of Example 8, and refraining from reporting the RLF includes: detecting the RLF associated with the source NTN entity; and refraining from transmitting a report indicating the RLF based on the message.

Example 11 may be the apparatus of Example 8, and refraining from reporting the RLF includes: refraining from detecting for the RLF associated with the source NTN entity based on the message.

Example 12 may be the apparatus of Example 1, and the connection is established further based on a conditional handover of the UE from the source NTN entity to the target NTN entity when a configuration associated with the conditional handover has been received from the source NTN entity.

Example 13 may be an apparatus at a source NTN entity that is configured for determining a first time period associated with a switch over of a feeder link from the source NTN entity to a target NTN entity; and transmitting a message indicating the switch over of the feeder link based on the first time period, the message further indicating a second time period associated with an availability of the target NTN entity.

Example 14 may be the apparatus of Example 13, and the message includes one of a SIB or a RRC Connection Release message.

Example 14 may be the apparatus of Example 14, and the SIB includes one of a SIB3 or a SIB19.

Example 16 may be the apparatus of Example 14, and the RRC Connection Release message includes redirection information identifying the target NTN entity.

Example 17 may be the apparatus of Example 13, and being further configured for: transmitting, in a single message to the target NTN entity, a respective context associated with each of a set of UE having a connection with the source NTN entity at the first time period.

Example 18 may be the apparatus of Example 13, and being further configured for: performing, before the second time period, handover of each of a set of UE to the target NTN entity based on the switch over of the feeder link associated with the first time period.

Example 19 may be the apparatus of Example 18, and being further configured for: transmitting, to at least one of the set of UE, a configuration associated with conditional handover to the target NTN entity, and the at least one of the set of UE is handed over to the target NTN entity based on the configuration.

Example 20 may be the apparatus of Example 13, and the second time period is offset from the first time period.

Example 21 may be the apparatus of Example 13, and the message further includes an indication that the switch over is associated with a RLF.

Example 22 may be an apparatus at a target NTN entity that is configured for: obtaining a feeder link at a first time period based on a switch over of the feeder link from a source NTN entity; and establishing a respective connection with each of a set of UE connected with the source NTN entity at the first time period based on a second time period indicated to each of the set of UE in a message from the source NTN entity.

Example 23 may be the apparatus of Example 22, and being further configured for: receiving, from the source NTN entity, a respective context associated with each of the set of UE, each of the set of UE having a connection with the source NTN entity at the first time period.

Example 24 may be the apparatus of Example 23, and the contexts respectively associated with the set of UE are received in a single message from the source NTN entity.

Example 25 may be the apparatus of Example 23, and being further configured for: communicating, over an Xn interface, information associated with a feeder link switch over from the source NTN entity to the target NTN entity.

Example 26 may be the apparatus of Example 25, and the information associated with the feeder link switch over includes at least one of: the first time period at which the feeder link switch over occurs, the second time period at which the target NTN entity is available, or an indication of whether the feeder link switch over is associated with a radio link failure.

Example 27 may be the apparatus of Example 22, and being further configured for: performing handover of each of the set of UE from the source NTN entity based on the switch over of the feeder link.

Example 28 may be the apparatus of Example 27, and the handover is based on a configuration associated with conditional handover from the source NTN entity, and at least one of the set of UE is handed over from the source NTN entity based on the configuration.

Example 29 may be the apparatus of Example 22, and the second time period is offset from the first time period.

Example 30 may be the apparatus of Example 22, and establishing a respective connection with each of the set of UE handed over from the source NTN entity based on the second time period indicated to each of the set of the UE in the message from the source NTN entity includes: receiving, from each of the set of UE, a respective request for RRC connection reestablishment based on the second time period; and reestablishing the respective connection with each of the set of UE based on the respective request.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
receiving, in a non-terrestrial network (NTN), a message indicating a feeder link switch over from a source NTN entity to a target NTN entity and a time period associated with the switch over;
establishing a connection associated with the target NTN entity based on the time period; and
refraining from reporting a radio link failure (RLF) associated with the source NTN entity based on the message.

2. The method of claim 1, wherein the message comprises one of a system information block (SIB) or a radio resource control (RRC) Connection Release message, wherein the SIB comprises one of a SIB3 or a SIB19.

3. (canceled)

4. The method of claim 2, wherein the RRC Connection Release message comprises redirection information, and wherein the connection is established further based on the redirection information.

5. The method of claim 1, further comprising:
identifying the target NTN entity based on information associated with the target NTN entity included in the message, wherein the connection is established further based on the information associated with the target NTN entity.

6. The method of claim 1, wherein the time period comprises at least one of a first time period at which the switch over occurs or a second time period at which the target NTN entity is available for establishing the connection, the second time period being offset from the first time period.

7. The method of claim 1, wherein establishing the connection associated with the target NTN entity based on the time period comprises:
transmitting a request for radio resource control (RRC) connection reestablishment to the target NTN entity based on the time period; and
reestablishing the connection associated with the target NTN entity based on the request.

8. (canceled)

9. The method of claim 1, wherein the message further comprises an indication that the switch over is associated with the RLF, and wherein the refraining from reporting the RLF is based on the indication that the switch over is associated with the RLF.

10. The method of claim 1, wherein refraining from reporting the RLF comprises:
detecting the RLF associated with the source NTN entity; and
refraining from transmitting a report indicating the RLF based on the message.

11. The method of claim 1, wherein refraining from reporting the RLF comprises:
refraining from detecting for the RLF associated with the source NTN entity based on the message.

12. The method of claim 1, wherein the connection is established further based on a conditional handover of the UE from the source NTN entity to the target NTN entity when a configuration associated with the conditional handover has been received from the source NTN entity.

13. A method of wireless communication at a source non-terrestrial network (NTN) entity, comprising:
determining a first time period associated with a switch over of a feeder link from the source NTN entity to a target NTN entity; and
transmitting a message indicating the switch over of the feeder link based on the first time period, the message further indicating a second time period associated with an availability of the target NTN entity.

14. The method of claim 13, wherein the message comprises one of a system information block (SIB) or a radio resource control (RRC) Connection Release message, wherein the SIB comprises one of a SIB3 or a SIB19.

15. (canceled)

16. The method of claim 14, wherein the RRC Connection Release message comprises redirection information identifying the target NTN entity.

17. The method of claim 13, further comprising:
transmitting, in a single message to the target NTN entity, a respective context associated with each of a set of user equipment (UE) having a connection with the source NTN entity at the first time period.

18. The method of claim 13, further comprising:
performing, before the second time period, handover of each of a set of user equipment (UE) to the target NTN entity based on the switch over of the feeder link associated with the first time period.

19. The method of claim 18, further comprising:
transmitting, to at least one of the set of UE, a configuration associated with conditional handover to the target NTN entity, wherein the at least one of the set of UE is handed over to the target NTN entity based on the configuration.

20. The method of claim 13, wherein the second time period is offset from the first time period.

21. The method of claim 13, wherein the message further comprises an indication that the switch over is associated with a radio link failure (RLF).

22-30. (canceled)

31. An apparatus for wireless communication at a user equipment (UE), comprising:
a memory; and
at least one processor coupled to the memory and configured to:
receive, in a non-terrestrial network (NTN), a message indicating a feeder link switch over from a source NTN entity to a target NTN entity and a time period associated with the switch over;
establish a connection associated with the target NTN entity based on the time period; and
refrain from reporting a radio link failure (RLF) associated with the source NTN entity based on the message.

32. The apparatus of claim 31, wherein the message comprises one of a system information block (SIB) or a radio resource control (RRC) Connection Release message, wherein the SIB comprises one of a SIB3 or a SIB19.

33-93. (canceled)
